(19) United States
(12) Patent Application Publication
(10) Pub. No.: US 2020/0042010 A1
(43) Pub. Date: Feb. 6, 2020

(54) AUTONOMOUS MOBILE APPARATUS, AUTONOMOUS MOVEMENT METHOD, AND NON-TRANSITORY RECORDING MEDIUM

(71) Applicant: CASIO COMPUTER CO., LTD., Tokyo (JP)

(72) Inventor: Mitsuyasu NAKAJIMA, Tokyo (JP)

(73) Assignee: CASIO COMPUTER CO., LTD., Tokyo (JP)

(21) Appl. No.: 16/525,946

(22) Filed: Jul. 30, 2019

(30) Foreign Application Priority Data
Jul. 31, 2018 (JP) 2018-144206

(51) Int. Cl. G05D 1/02

(52) U.S. Cl. CPC G05D 1/0246; G05D 1/0268

(57) ABSTRACT

An autonomous mobile apparatus creates an environment map and estimates a position using images captured by an imaging device. The autonomous mobile apparatus includes a controller and a storage unit. The controller creates environment maps in accordance with changes in the surrounding environment, normalizes the created environment maps to enable unified handling and saves the normalized environment maps in the storage unit, and estimates the position using the normalized environment maps.

### CROSS-REFERENCE TO RELATED APPLICATION

This application claims the benefit of Japanese Patent Application No. 2018-144206, filed on Jul. 31, 2018, the entire disclosure of which is incorporated by reference herein.

### FIELD

This application relates generally to an autonomous mobile apparatus, an autonomous movement method, and a non-transitory recording medium.

### BACKGROUND

Autonomous mobile apparatuses that create environment maps and move autonomously are commonly used. Examples of such apparatuses include vacuum cleaner robots that automatically clean rooms. In many cases, these autonomous mobile apparatuses perform Visual Simultaneous Localization And Mapping (vSLAM) processing. In this processing, a camera is used to simultaneously perform self position estimation and environment map creation. Moreover, in vSLAM processing, the self position estimation and the environment map creation is performed on the basis of feature points included in the image captured by the camera. As such, the accuracy of the self position estimation and the content of the environment map that is created are heavily influenced by the environment such as the lighting and the like. Therefore, when using an environment map to estimate the self position in an environment that differs from the environment (for example, the lighting) at the time of creation of that environment map, the performance of the position estimation declines significantly. International Publication No. WO 2016/016955 describes a technique to solve this problem. Specifically, International Publication No. WO 2016/016955 describes an autonomous mobile apparatus in which the influence of disturbances is suppressed by estimating the self position on the basis of an arrangement of landmarks in the surrounding environment.

### SUMMARY

According to an aspect of the present disclosure, an autonomous mobile apparatus includes a processor and a memory. The processor is configured to use captured images to create environment maps in accordance with changes in a surrounding environment, normalize the created environment maps to enable unified handling, and save the normalized environment maps in the memory, and estimate a position of the autonomous mobile apparatus using the normalized environment maps.

### BRIEF DESCRIPTION OF THE DRAWINGS

A more complete understanding of this application can be obtained when the following detailed description is considered in conjunction with the following drawings, in which:

FIG. 1 is a drawing illustrating the appearance of an autonomous mobile apparatus according to Embodiment 1 of the present disclosure;

FIG. 2 is a drawing illustrating the appearance of a charger according to Embodiment 1;

FIG. 3 is a drawing explaining a feedback signal sent by the charger according to Embodiment 1;

FIG. 4 is a drawing illustrating the functional configuration of the autonomous mobile apparatus according to Embodiment 1;

FIG. 5 is a drawing illustrating the data structure of an environment map created by the autonomous mobile apparatus according to Embodiment 1;

FIG. 6 is a flowchart of startup processing of the autonomous mobile apparatus according to Embodiment 1;

FIG. 7 is a flowchart of a self position estimation thread of the autonomous mobile apparatus according to Embodiment 1;

FIG. 8 is a flowchart of environment map extraction processing of the autonomous mobile apparatus according to Embodiment 1;

FIG. 9 is a flowchart of relocalization processing of the autonomous mobile apparatus according to Embodiment 1;

FIG. 10 is a flowchart of attitude estimation processing of the autonomous mobile apparatus according to Embodiment 1;

FIG. 11 is a flowchart of environment map saving processing of the autonomous mobile apparatus according to Embodiment 1;

FIG. 12 is a flowchart of environment map normalization processing of the autonomous mobile apparatus according to Embodiment 1;

FIG. 13 is a flowchart of attitude conversion matrix error correction processing of the autonomous mobile apparatus according to Embodiment 1;

FIG. 14 is a flowchart of ICP processing of the autonomous mobile apparatus according to Embodiment 1;

FIG. 15 is a flowchart of environment map saving processing of the autonomous mobile apparatus according to Modified Example 1 of Embodiment 1 of the present disclosure;

FIG. 16 is a drawing illustrating the data structure of an environment map created by an autonomous mobile apparatus according to Embodiment 2 of the present disclosure;

FIG. 17 is a flowchart of environment map saving processing of the autonomous mobile apparatus according to Embodiment 2; and

FIG. 18 is a flowchart of environment map normalization processing of the autonomous mobile apparatus according to Embodiment 2.

### DETAILED DESCRIPTION

Hereinafter, autonomous mobile apparatuses according to embodiments of the present disclosure are described while referencing the drawings and tables. Note that, in the drawings, identical or corresponding components are marked with the same reference numerals.

### Embodiment 1

The autonomous mobile apparatus according to the present embodiment creates maps (environment maps) and, at the same time, autonomously moves in accordance with the application of the autonomous mobile apparatus. Examples of the application include security/monitoring, room cleaning, pet, toy, and the like.

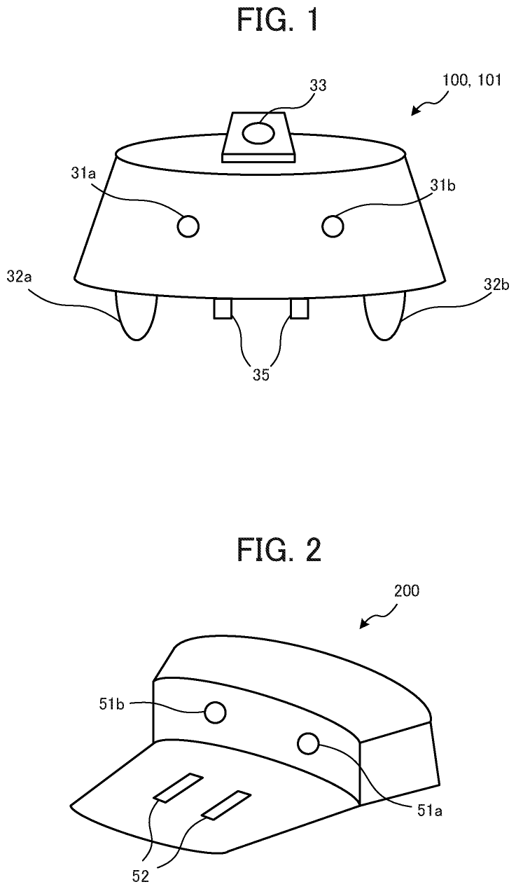

As illustrated in FIG. 1, the autonomous mobile apparatus 100 according to Embodiment 1 includes, in appearance, feedback signal receivers 31 (31a, 31b), drivers 32 (32a, 32b), an imaging device 33, and charging connectors 35. While not illustrated in FIG. 1, the autonomous mobile apparatus 100 may also include an obstacle sensor that detects objects (obstacles) present in the surroundings of the autonomous mobile apparatus 100. As illustrated in FIG. 2, a charger 200 for charging the battery of the autonomous mobile apparatus 100 includes, in appearance, feedback signal transmitters 51 (51a, 51b), and power suppliers 52.

The battery installed in the autonomous mobile apparatus 100 can receive a supply of power from the charger 200 and be charged as a result of the charging connectors 35 of the autonomous mobile apparatus 100 connecting to the power suppliers 52 of the charger 200. The charging connectors 35 and the power suppliers 52 are connection terminals that respectively connect to each other. These connection terminals connect to each other as a result of the autonomous mobile apparatus 100 being moved onto the charger 200 by the drivers 32. The charging connectors 35 may be brought into contact with the power suppliers 52 to make this connection. Alternatively, the charging connectors 35 and the power suppliers 52 may be brought into proximity with each other and electromagnetic induction or the like may be utilized to make this connection.

The imaging device 33 is a camera that includes a wide angle lens capable of capturing a wide range spanning from in front to above the autonomous mobile apparatus 100. Due to this configuration, the imaging device 33 can capture an image from which it is possible to determine whether a light on the ceiling is turned ON. Moreover, the autonomous mobile apparatus 100 is capable of performing monocular simultaneous localization and mapping (SLAM) processing using the image captured by the imaging device 33.

The feedback signal receivers 31 of the autonomous mobile apparatus 100 are devices for receiving feedback signals (infrared beacons) sent from the charger 200. The autonomous mobile apparatus 100 includes a total of two feedback signal receivers 31, namely a feedback signal receiver 31a provided to the left and a feedback signal receiver 31b provided to the right when facing the front of the autonomous mobile apparatus 100. The feedback signal transmitters 51 of the charger 200 are devices for sending feedback signals to the autonomous mobile apparatus 100. The charger 200 includes two feedback signal transmitters, namely a feedback signal transmitter 51a provided to the right and a feedback signal transmitter 51b provided to the left when facing the front of the charger 200. The feedback signal sent from the feedback signal transmitter 51a and the feedback signal sent from the feedback signal transmitter 51b are different signals. Accordingly, the feedback signal receivers 31 can determine whether a feedback signal is received from the left or right feedback signal transmitter 51.

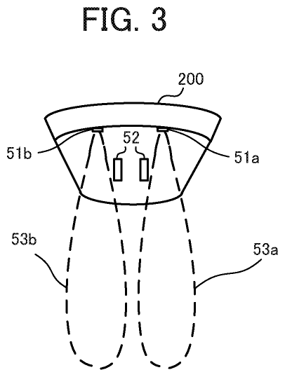

FIG. 3 illustrates an example of receivable ranges 53 (53a, 53b) of each of the left and right feedback signals sent from the feedback signal transmitters 51 of the charger 200. The feedback signal sent from the feedback signal transmitter 51a can be received when the feedback signal receivers 31 of the autonomous mobile apparatus 100 enter into the receivable range 53a. The feedback signal sent from the feedback signal transmitter 51b can be received when the feedback signal receivers 31 of the autonomous mobile apparatus 100 enter into the receivable range 53b. Accordingly, the autonomous mobile apparatus 100 can ascertain the direction in which the charger 200 is present when the autonomous mobile apparatus 100 enters into the receivable range 53. Moreover, the autonomous mobile apparatus 100 can move onto the charger 200 by advancing while adjusting the orientation such that the feedback signal receiver 31a receives the feedback signal from the feedback signal transmitter 51a and the feedback signal receiver 31b receives the feedback signal from the feedback signal transmitter 51b. When the autonomous mobile apparatus 100 moves onto the charger 200, the charging connectors 35 connect to the power suppliers 52, and the battery installed in the autonomous mobile apparatus 100 can be charged.

The drivers 32 are independent two-wheel drive-type drivers. The drivers 32 are movement devices that each include a wheel and a motor. The autonomous mobile apparatus 100 can perform parallel movement (translational movement) by the two wheels being driven in the same direction, rotating in place (orientation change) by the two wheels being driven in opposite directions, and turning movement (translational+rotational (orientation change) movement) by the two wheels being respectively driven at different speeds. Each of the wheels is provided with a rotary encoder. The amount of translational movement and the amount of rotation can be calculated by measuring the rotational speed of the wheel by the rotary encoder, and using the diameter of the wheel, the distance between the wheels, and other geometrical relationships. In one example, when the diameter of the wheel is D and the rotational speed is R (measured by the rotary encoder), the amount of translational movement at the ground contact section of that wheel is expressed as R×D×R. In another example, when the diameter of the wheel is D, the distance between the wheels is I, the rotational speed of the right wheel is RR, and the rotational speed of the left wheel is RL, the amount of rotation of the orientation change (where rotation to the right is defined as positive) is expressed as 360°×D×(RL−RR)/(2×I). By successively adding the amount of translational movement and the amount of rotation together, the drivers 32 can function as so-called odometers (mechanical odometers) and measure the self position (position and orientation of the autonomous mobile apparatus 100 based on the position and orientation at the start of movement).

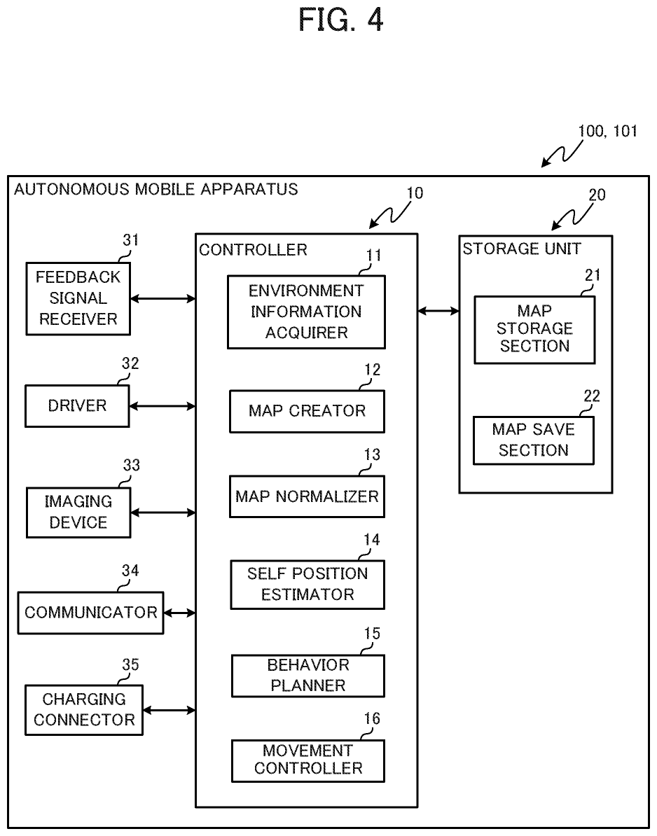

As illustrated in FIG. 4, the autonomous mobile apparatus 100 includes a controller 10, a storage unit 20, and a communicator 34 in addition to the feedback signal receivers 31 (31a, 31b), the drivers 32 (32a, 32b), the imaging device 33, and the charging connectors 35.

The controller 10 is configured from a central processing unit (CPU) or the like. The controller 10 executes a program stored in the storage unit 20 to realize the functions of the hereinafter described components (an environment information acquirer 11, a map creator 12, a map normalizer 13, a self position estimator 14, a behavior planner 15, and a movement controller 16). Additionally, a configuration is possible in which the controller 10 further includes a clock (not illustrated in the drawings), and is capable of acquiring the current time and date and counting elapsed time.

The storage unit 20 is configured from read-only memory (ROM), random access memory (RAM), or the like. The ROM is configured in part or in whole from electrically rewritable memory (flash memory or the like). Functionally, the storage unit 20 includes a map storage section 21 and a map save section 22. Programs to be executed by the CPU of the controller 10 and data needed in advance to execute these programs are stored in the ROM. Data that is created or modified during the execution of the program is stored in the RAM.

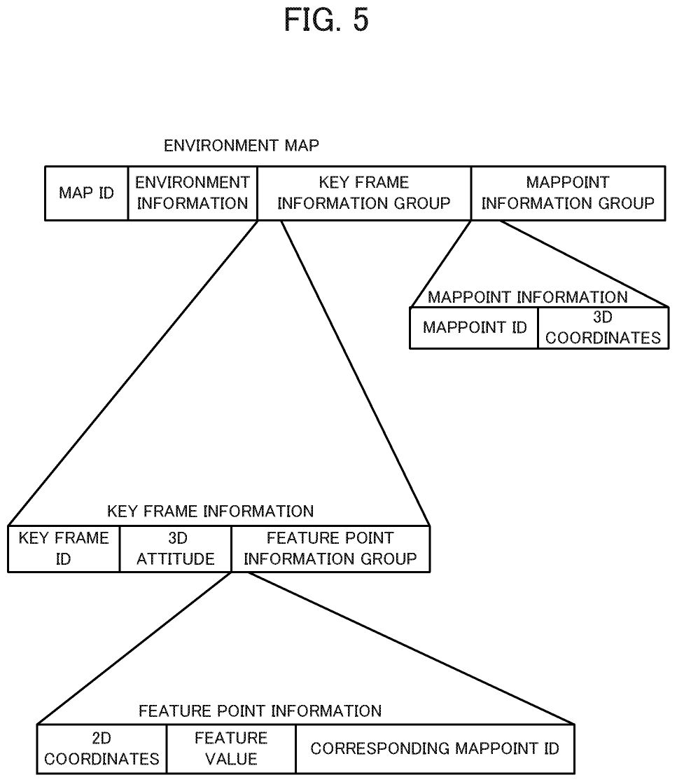

The map storage section 21 stores environment maps that the map creator 12 created, by SLAM processing, on the basis of information in the image captured by the imaging device 33. As illustrated in FIG. 5, each environment map includes a map ID (identifier), environment information, a key frame information group, and a MapPoint information group. The map ID is an ID whereby each environment map is uniquely identified. The environment information is information about the surrounding environment, such as ambient brightness.

The environment information is information that is thought to affect the position estimation by the SLAM processing. Here, the environment information from when the key frame information group and the MapPoint information group are acquired is stored.

The term “key frame” refers to a frame, among the images (frames) captured by the imaging device 33 in the SLAM processing, that is to be used in the estimation of the three-dimensional (3D) position. The term “MapPoint” refers to a 3D coordinate point (point in 3D space) of a feature point for which the coordinates of the 3D position in the environment map (3D space) have been successfully estimated by the SLAM processing.

As illustrated in FIG. 5, the key frame information includes a key frame ID whereby the key frame is uniquely identified, a 3D attitude (position and orientation) within the environment map (3D space) of the imaging device 33 (the autonomous mobile apparatus 100) from when the key frame was captured, and feature point information that is information about the feature point included in the key frame (typically, a plurality of feature points are included in one key frame and, as such, is referred to as a “feature point information group”).

Among these, in order to facilitate calculation of the rotation and the translation, the 3D attitude is expressed by a (4×4) attitude matrix in homogeneous coordinate format. In this attitude matrix, a (3×3) rotation matrix representing the orientation and a (3×1) position matrix (position vector) representing the position (3D coordinates) are expressed by a single matrix. As such, an attitude conversion matrix (described later) is a 4×4 matrix expressed in homogeneous coordinate format, including a rotation matrix and a position matrix. Note that among rotation matrices, there are right-handed coordinate systems in which the vector to be acted on is noted on the right side of the matrix, and left-handed coordinate systems in which the vector to be acted on is noted on the left side of the matrix. In the present embodiment, a right-handed coordinate system rotation matrix is used.

The “feature points included in the key frame” are points of characteristic portions in the image. Examples thereof include edges, corners, and the like in the key frame (image). The feature points can be detected by an algorithm such as Scale-Invariant Feature Transform (SIFT), Speeded Up Robust Features (SURF), and Features from Accelerated Segment Test (FAST). As illustrated in FIG. 5, the feature point information includes 2D coordinates of each feature point in the key frame, a feature value of that feature point and, if the 3D coordinate point of that feature point in the environment map is estimated, the ID of the MapPoint that corresponds to that feature point. If the 3D coordinates of that feature point are not yet estimated, a special ID (for example, 0) that indicates that the 3D coordinates are not yet estimated is stored in the “Corresponding MapPoint ID” field. Note that, an oriented FAST and Rotated BRIEF (ORB) feature can be used as the feature value of the feature point.

As illustrated in FIG. 5, the MapPoint information includes a MapPoint ID that is an ID whereby the MapPoint is uniquely identified, and 3D coordinates of that MapPoint in the environment map. Accordingly, by referencing the MapPoint information on the basis of the “Corresponding MapPoint ID” included in the feature point information, the 3D coordinates of that feature point in the environment map can be acquired.

The environment information is information about the surrounding environment. Examples of the environment information include ON/OFF states of lights, ambient brightness, and time. The environment information is information that is thought to affect the position estimation of the autonomous mobile apparatus 100. While information that is related to brightness (the ON/OFF states of lights, whether curtains are open or closed, sunlight conditions through windows (morning or evening, weather), and the like) is the main type of information that is significant as environment information, the number of people, arrangement of furniture, and other information may also be included in the environment information. Additionally, while information such as temperature, humidity, barometric pressure, and the like do not directly affect the position estimation, the position estimation is affected if the arrangement of the room or the number of people coming and going changes due to these pieces of information. As such, these pieces of information may also be included in the environment information. Note that, in the present embodiment, the number of lights that are ON is used as the environment information. The number of lights that are ON can be obtained as the number of regions where brightness is high (regions where the brightness is greater than or equal to a predetermined brightness reference value) in an image in which the ceiling is captured.

The map save section 22 is provided in the electrically rewritable ROM (flash memory or the like) of the storage unit 20. The environment map stored in the map storage section 21 is saved in the map save section 22 so that the environment map does not disappear after the power of the autonomous mobile apparatus 100 is turned OFF.

The communicator 34 is a wireless module that includes an antenna. The communicator 34 is for wirelessly communicating with the charger 200 and other external devices. In one example, the communicator 34 is a wireless module for carrying out short-range wireless communication based on Bluetooth (registered trademark). By using the communicator 34, the autonomous mobile apparatus 100 can exchange data with external devices and the like.

Next, the functional components of the controller 10 of the autonomous mobile apparatus 100 will be described. The controller 10 realizes the functions of the environment information acquirer 11, the map creator 12, the map normalizer 13, the self position estimator 14, the behavior planner 15, and the movement controller 16. The controller 10 creates the environment map, performs estimation of the attitude (position and orientation) of the autonomous mobile apparatus 100 and movement control of the autonomous mobile apparatus 100, and the like. Additionally, when the controller 10 is compatible with multithreading functionality, the controller 10 can execute a plurality of threads (different processing flows) in parallel.

The environment information acquirer 11 acquires, on the basis of the image data captured by the imaging device 33, the number of lights that are ON as the environment information representing the surrounding environment of the autonomous mobile apparatus 100. Note that this is merely one example of the environment information. When other information such as the ON/OFF states of the lights, brightness information, and the like is to be used as the environment information, the environment information acquirer 11 acquires this other information. Moreover, when time and date information is included in the environment information to be used, the environment information acquirer 11 acquires the current time and date from the clock of the controller 10.

The map creator 12 uses the imaging data captured by the imaging device 33 to create, by SLAM processing, environment map data that includes the key frame information group and the MapPoint information group illustrated in FIG. 5, and writes this environment map data to the map storage section 21.

The map normalizer 13 normalizes, by map normalization processing (described later), the environment map data created by the map creator 12.

The self position estimator 14 uses the image data captured by the imaging device 33 and the environment map data stored in the map storage section 21 to estimate, by SLAM processing, the attitude (position and orientation) of the autonomous mobile apparatus 100 in the coordinate system of the environment map. Note that, reciting “attitude (position and orientation)” at each occurrence is laborious and, as such, in the present description and in the claims, when the term “position” is used alone, it may be construed to refer to both position and orientation. That is, in some cases, the term “position” should be interpreted as “attitude (position and orientation).” In particular, the “estimation of the self position” should be construed to mean the estimation of the attitude (position and orientation) of the apparatus (the autonomous mobile apparatus 100).

The behavior planner 15 sets a destination and a route on the basis of the environment map stored in the map storage section 21 and an operation mode. The “operation mode” determines the behavior mode of the autonomous mobile apparatus 100. In one example, the autonomous mobile apparatus 100 has a plurality of operation modes such as “wandering mode” in which the autonomous mobile apparatus 100 randomly moves, “map creation mode” in which the autonomous mobile apparatus 100 expands the creation range of a map, and “specific destination mode” in which the autonomous mobile apparatus 100 moves to a location specified from a main thread or the like (described later). Change conditions may be set, in advance, for the operation modes. For example, the initial value may be set to map creation mode, the mode may change to the wandering mode when the map is created to a certain degree (for example, when 10 minutes have elapsed in map creation mode), and the mode may change to the specific destination mode in which the position of the charger 200 is specified as the destination when the battery level is low. Moreover, the operation mode may be set by external commands (for example, from a user, from a main thread, or the like). When the behavior planner 15 sets the route, a route from the current position of the autonomous mobile apparatus 100 to the destination is set on the basis of the environment map created by the map creator 12.

The movement controller 16 controls the drivers 32 so as to cause the autonomous mobile apparatus 100 to move along the route set by the behavior planner 15.

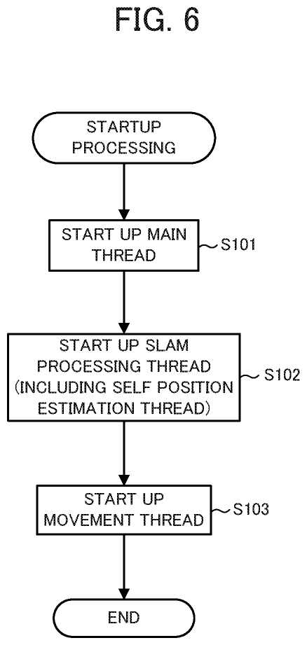

The functional configuration of the autonomous mobile apparatus 100 is described above. Next, the various types of processing started by the autonomous mobile apparatus 100 will be described. The autonomous mobile apparatus 100 is charged by being connected to the charger 200 while the power is OFF. When the power is turned ON while the autonomous mobile apparatus 100 is connected to the charger 200, startup processing (described later) is executed, various threads, such as the main thread, are started in parallel, and processing corresponding to the application of the autonomous mobile apparatus 100 is performed. The processing at startup of the autonomous mobile apparatus 100 will be described while referencing FIG. 6. FIG. 6 is a flowchart of the startup processing that is executed when the autonomous mobile apparatus 100 is started up.

First, the controller 10 of the autonomous mobile apparatus 100 starts up the main thread (step S101). The main thread receives, from a self position estimation thread started in the next step, information about the current attitude (position and orientation) of the autonomous mobile apparatus 100 in the environment map, to perform the processing corresponding to the application of the autonomous mobile apparatus 100 (for example, processing for room cleaning).

Next, the controller 10 starts various threads for the SLAM processing (step S102). The “various threads for the SLAM processing” include a self position estimation thread for estimating the attitude (position and orientation) of the autonomous mobile apparatus 100, a map creation thread for creating an environment map, a loop closing thread for performing loop closing processing, and the like. Note that the “loop closing processing” is processing in which, when it is recognized that the autonomous mobile apparatus 100 has returned to a location that has previously been visited, the variance between the attitude of the autonomous mobile apparatus 100 when previously at that location and the current attitude is used to correct the (3D attitudes of the) key frames along the movement trajectory from the previous visit to present and/or the (3D coordinates of the) the related MapPoints.

Next, the controller 10 starts a movement thread (step S103) and ends the startup processing. The movement thread is a thread that receives a movement command from the main thread and performs processing in which the movement controller 16 controls the drivers 32 to move the autonomous mobile apparatus 100. After the startup processing is ended, the autonomous mobile apparatus 100 is controlled by the various threads started by the startup processing.

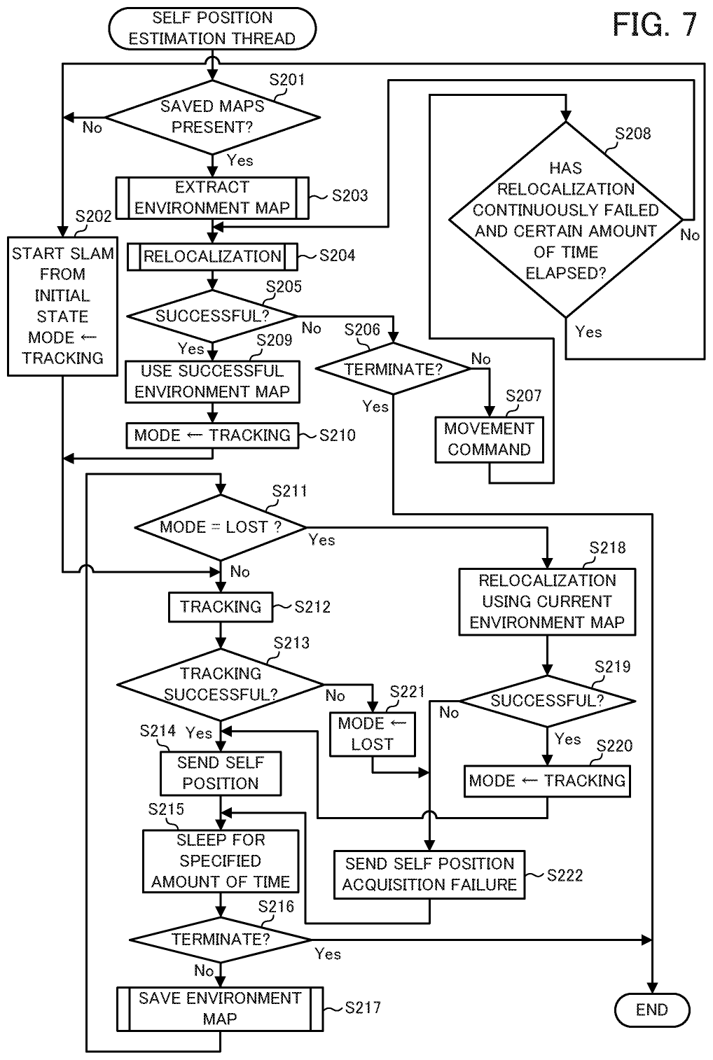

The self position estimation thread of threads for the SLAM processing will be described while referencing FIG. 7. The self position estimation thread is a thread that selects the environment map that matches the current environment from among the environment maps saved in the map save section 22, and uses the selected environment map to perform tracking processing (self position estimation processing).

First, the controller 10 determines whether an environment map is saved in the map save section 22 (step S201). If an environment map is not saved in the map save section 22 (step S201; No), the controller 10 starts the SLAM processing from the initial state, sets TRACKING for the variable MODE (step S202), and executes step S212. Note that the variable MODE is a variable that indicates if the autonomous mobile apparatus 100 is currently in a state in which the self position can be estimated (TRACKING state) or is in a state in which the self position cannot be estimated (LOST state). Here, “START SLAM FROM INITIAL STATE” in step S202 means that the controller 10 starts the self position estimation and the environment map creation on the basis of the correspondences of the feature points between two images captured by the imaging device 33 while the autonomous mobile apparatus 100 is moving after the environment map is cleared. If the number of correspondences of the feature points between the two images is five or greater, the attitude (the difference in the position (translation vector t) and the difference in the direction (rotation matrix R) where each image was acquired) between the two images can be estimated by using the two-view structure from motion method. As such, the controller 10 can eventually estimate the attitude between the two images by using the imaging device 33 to continuously acquire images until the number of correspondences of the feature points is five or greater. Moreover, this estimated attitude can be considered to be the self position (position and orientation) at acquisition of the second image for a case in which the position where the first image was acquired is set as the origin. Moreover, thereafter, the controller 10 can write the estimated attitude and information about the feature points to the map storage section 21 as information about the environment map and, simultaneously, estimate the self position from the feature points included in the environment map and the feature points in the images acquired by the imaging device 33. This processing is SLAM processing.

When an environment map is saved in the map save section 22 (step S201; Yes), the controller 10 performs environment map extraction processing in which the environment map with the highest possibility of matching the current environment is extracted from the environment maps saved in the map save section 22 (step S203). A detailed description of the environment map extraction processing is given later.

Then, the controller 10 performs relocalization processing in which the self position is estimated using an environment map while the current self position is unknown (step S204). A detailed description of the relocalization processing is given later.

Then, the controller 10 determines whether the relocalization processing is successful (step S205). If the relocalization processing has failed (step S205; No), the controller 10 determines whether there is an end command from the main thread or the user (step S206). If there is an end command (step S206; Yes), the self position estimation thread is ended. If there is not an end command (step S206; No), movement is performed by sending a movement command to the movement thread (step S207). Note that the movement in step S207 is a movement for changing the image acquired first in the relocalization processing. As such in, for example, a case in which the autonomous mobile apparatus 100 is moving due to the processing of another thread that is being executed in parallel, there is no need to move the autonomous mobile apparatus 100 again in step S207.

Then, the controller 10 determines whether the relocalization processing in step S204 has failed continuously for a predetermined amount of time or longer (step S208). In one example, this determination is performed as follows by introducing a variable RFC that records the failure of the relocalization processing and a variable RFT that records the time at which the variable RFC becomes 1. When the relocalization processing is successful, the variable RFC and the variable RFT are initialized to 0, and when the relocalization processing fails, 1 is added to the variable RFC. When the variable RFC becomes 1, the time at that instant is recorded in the variable RFT. Moreover, in step S208, it is determined whether the current time is a predetermined amount of time (for example, five minutes) after the time recorded in the variable RFT.

If the relocalization processing has failed continuously for the predetermined amount of time or longer (step S208; Yes), step S202 is executed and the processing is repeated from the initialization of the SLAM processing (and the clearing of the map storage section 21). If the relocalization processing has failed but the predetermined amount of time has not elapsed (step S208; No), step S204 is executed and the relocalization processing is performed again. Note that a configuration is possible in which the determination in step S208 includes determining whether the relocalization processing has continuously failed a predetermined number of times (for example, five times) instead of for the predetermined amount of time. This determination can be performed on the basis of whether the aforementioned value of the variable RFC has been reached a predetermined number of times or more.

Meanwhile, when the relocalization processing is successful (step S205; Yes), the controller 10 reads, to the map storage section 21, the environment map selected when the relocalization processing was successful, and uses this environment map in the subsequent self position estimation (step S209). Then, the controller 10 sets TRACKING for the variable MODE (step S210), and executes step S212.

In step S212, the self position is estimated by SLAM-based tracking processing. In this tracking processing, first, the feature points are extracted from the image data captured by the imaging device 33, and the feature values are used to acquire the correspondence between the extracted feature points and the feature points of the key frame included in the environment map, for which the 3D coordinates are already estimated. Provided that the number of feature points with correspondence (corresponding feature points) is greater than or equal to a trackable reference number (for example, 10), the controller 10 can estimate the self position from the relationship between the 2D coordinates in the image and the 3D coordinates in the environment map of the corresponding feature points. Such a case is referred to as a tracking success. When the number of corresponding points is less than the trackable reference number, the error when evaluating the self position increases. As such, in such cases, the controller 10 determines that the tracking has failed and does not estimate the self position.

After the tracking processing, the controller 10 determines whether the tracking processing is successful (step S213). If the tracking processing is successful (step S213; Yes), the controller 10 sends the self position acquired by the tracking processing to the main thread (step S214). Then, the controller 10 sleeps for a predetermined amount of time (for example, 10 seconds) (step S215).

If the tracking processing has failed (step S213; No), the controller 10 sets LOST for the variable MODE (step S221), sends a notification indicating that self position acquisition has failed to the main thread (step S222), executes step S215, and sleeps for the predetermined amount of time.

Then, the controller 10 determines whether there is an end command from the main thread or the user (step S216). If there is an end command (step S216; Yes), the self position estimation thread is ended. If there is not an end command (step S216; No), environment map saving processing, which is processing for normalizing and saving the environment map in the map save section 22, is performed (step S217). A detailed description of the environment map saving processing is given later.

Next, the controller 10 determines whether the value set for the variable MODE is LOST (step S211). If the value set for the variable MODE is not LOST (step S211; No), the value set is TRACKING and, as such, step S212 is executed and tracking processing is performed.

If the value set for the variable MODE is LOST (step S211; Yes), the controller 10 performs the relocalization processing using the environment map that is current being used (the environment map that is read to the map storage section 21) (step S218), and determines whether that relocalization processing is successful (step S219). If the relocalization processing is successful (step S219; Yes), the controller 10 sets TRACKING for the variable MODE (step S220), and executes step S214. If the relocalization processing has failed (step S219; No), step S222 is executed.

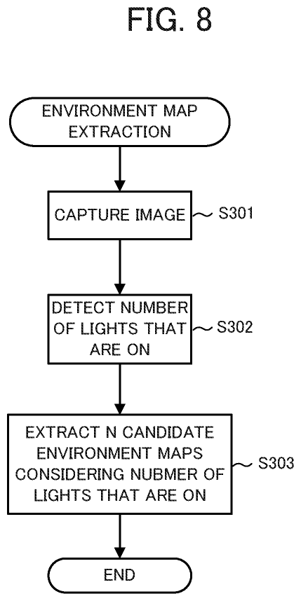

This ends the description of the processing of the self position estimation thread. Next, the environment map extraction processing that is executed in step S203 of the self position estimation thread (FIG. 7) is described while referencing FIG. 8. In this processing, the environment map with the highest possibility of matching the current environment is extracted from the plurality of environment maps saved in the map save section 22 by extracting the environment map that includes environment information that matches or is similar to current environment information.

First, the controller 10 captures an image using the imaging device 33 (step S301). Then, the number of lights that are ON is detected by calculating the number of regions in the image where brightness is high (regions where the brightness is greater than or equal to a predetermined brightness reference value) (step S302).

The controller 10 extracts a predetermined number (N) of environment map candidates from among the plurality of environment maps saved in the map save section 22 (step S303), and ends the environment map extraction processing. The environment map candidates have the same or similar environment information (number of lights that are ON). When extracting the environment maps, N environment maps are extracted in order of similarity between the environment information added to each environment map and the current environment information. The N extracted environment maps are candidates for the environment map to be used later and, as such, are referred to as candidate environment maps. Note that, N may be set to an arbitrary number such as five. However, when the number of environment maps saved in the map save section 22 is low, there may be cases in which it is only possible to extract fewer than N candidate environment maps.

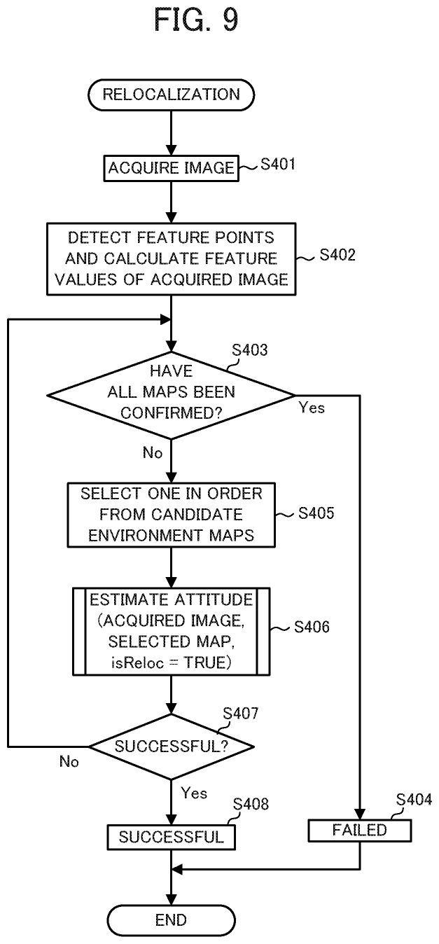

As a result of the environment map extraction processing described above, N candidate environment maps for which the environment information matches or is similar to the current environment information are extracted from among the plurality of environment maps saved in the map save section 22. Next, the relocalization processing that is executed in step S204 of the self position estimation thread (FIG. 7) is described while referencing FIG. 9. The relocalization processing is processing for estimating, while the current self position is unknown, the self position using an environment map.

First, the controller 10 captures and acquires an image using the imaging device 33 (step S401). Then, the controller 10 detects the feature points in the image and calculates the feature value of each of the detected feature points (step S402). Any method can be used to detect the feature points and any feature value may be used. For example, the controller 10 can use FAST as the detection method of the feature points and ORB as the feature value of the feature points.

Next, the controller 10 determines whether the feature point correspondences are confirmed for all of the N candidate environment maps extracted in the previously performed environment map extraction processing (step S403). If the feature point correspondences are confirmed for all of the candidate environment maps (step S403; Yes), it is determined that the relocalization processing has failed (step S404), and the relocalization processing is ended.

If candidate environment maps remain for which the feature point correspondences have not been confirmed (step S403; No), the controller 10 selects, in order, one of the remaining candidate environment maps (step S405). Then, the controller 10 performs attitude estimation processing on the basis of the image acquired in step S401 and the environment map selected in step S405 (step S406). As described later, the attitude estimation processing is a subroutine that accepts three arguments, namely an image A captured at the attitude to be estimated, an environment map B to be used in the attitude estimation, and a flag variable isReloc that indicates whether the processing is the relocation processing. Here, the attitude estimation processing is called as a result of true being set for the flag variable isReloc. A detailed description of the attitude estimation processing is given later.

Then, the controller 10 determines whether the attitude estimation is successful (step S407). If the attitude estimation processing has failed (step S407; No), step S403 is executed. If the attitude estimation processing is successful (step S407; Yes), it is determined that the relocalization processing is successful (step S408), and the relocalization processing is ended.

As a result of the relocalization processing described above, the autonomous mobile apparatus 100 can select, on the basis of the image captured by the imaging device 33, an environment map whereby the attitude (the position and orientation) of the autonomous mobile apparatus 100 can be estimated.

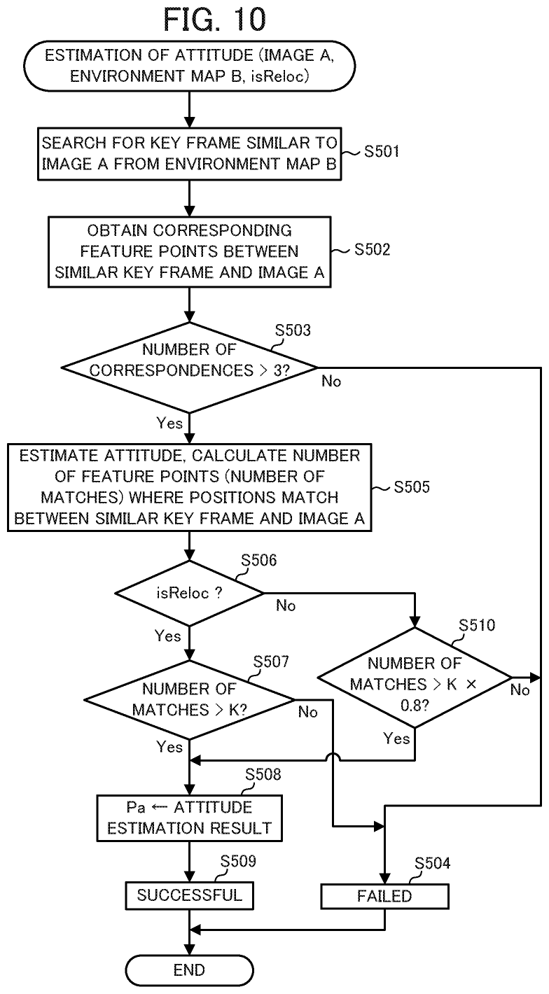

Next, the attitude estimation processing that is called in step S406 of the relocalization processing (FIG. 9) is described while referencing FIG. 10. As described above, the attitude estimation processing accepts three arguments. As such, in the following, the image A, the environment map B, and the flag variable isReloc are described.

First, the controller 10 searches for a similar key frame that is similar to the image A from among the key frame information group of the environment map B (step S501). Any method may be used to search for the similar key frame. For example, rapid searching can be performed by classifying all of the key frames in the environment map B according to the histograms of the feature values, and performing a similarity search on the basis of the similarity between these histograms and the histograms of the feature values of the image A.

Then, the controller 10 establishes, on the basis of the feature values, correspondence between the feature points of image A and the feature points, for which the 3D coordinates are estimated, among the feature points of the similar key frame found in step S501. For example, when the similarity between the feature value of one feature point (for which the 3D coordinates are estimated) in the similar key frame and the feature value of a feature point in the image A is greater than a predetermined reference similarity, it is determined that these two feature points have correspondence (that is, are corresponding feature points). Then, the controller 10 calculates the number of these corresponding feature points (step S502).

Next, the controller 10 determines whether the number of corresponding feature points is greater than 3 (step S503). If the number of corresponding feature points is three or less (step S503; No), it is determined that the attitude estimation has failed (step S504), and the attitude estimation processing is ended. Note that, a configuration is possible in which, instead of immediately determining that the attitude estimation has failed, step S501 is returned to and a similar key frame (second or lower in order of similarity) that was not found the previous time is searched for among the key frames that are similar to the image A. A reason this is possible is because there may be many corresponding feature points even though the similarity is not high. In such a case, if the number of corresponding feature points is three or less (step S503; No) after returning to step S501 a predetermined number of times (for example, three) and calculating the number of corresponding feature points in other similar key frames, the attitude estimation is determined as having failed (step S504), and the attitude estimation processing is ended.

If the number of corresponding feature points is greater than 3 (step S503; Yes), step S505 is executed. When four or more of the feature points in the image A have correspondence with the feature points (for which the 3D coordinates are estimated) in the similar key frame, it is possible to estimate, as a perspective-n-point (PnP) problem, the attitude (position and orientation) of the autonomous mobile apparatus 100 at the time of acquiring the image A.

In step S505, the controller 10 solves this PnP problem, thereby estimating the attitude of the autonomous mobile apparatus 100, and uses this estimated attitude to calculate the error (correspondence error) between the 2D coordinates of the feature point (regardless of whether the 3D coordinates are estimated) in the similar key frame and the 2D coordinates of the feature point in the image A that corresponds to that feature point. If this correspondence error is less than or equal to a reference error T, it is determined that the position of that feature point matches, and the controller 10 calculates the number (number of matches) of corresponding feature points that match in this manner (step S505).

Then, the controller 10 determines whether true is set for the flag variable isReloc (step S506). If true is set for the flag variable isReloc (step S506; Yes), the controller 10 determines whether the number of matches is greater than a reference match value K (for example, 50) (step S507). If the number of matches is less than or equal to the reference match value K (step S507; No), it is determined that the attitude estimation has failed (step S504), and the attitude estimation processing is ended. If the number of matches is greater than the reference match value K (step S507; Yes), the controller 10 estimates the attitude by adding the attitude estimated in step S505 to the 3D attitude of the similar key frame, and sets the estimated result in a matrix Pa (step S508). Then, it is determined that the attitude estimation is successful (step S509), and the attitude estimation processing is ended.

If, in step S506, the true is not set for the flag variable isReloc (step S506; No), the controller 10 determines whether the number of matches is greater than a 0.8× the reference match value K (for example, 10) (step S510). If the number of matches is less than or equal to 0.8× the reference match value K (step S510; No), it is determined that the attitude estimation has failed (step S504), and the attitude estimation processing is ended. If the number of matches is greater than 0.8× the reference match value K (step S510; Yes), the controller 10 estimates the attitude by adding the attitude estimated in step S505 to the 3D attitude of the similar key frame, and sets the estimated result in the matrix Pa (step S508). Then, it is determined that the attitude estimation is successful (step S509), and the attitude estimation processing is ended.

As a result of the attitude estimation processing described above, when the variable isReloc=true, the autonomous mobile apparatus 100 can estimate the attitude (position and orientation) of the autonomous mobile apparatus 100. Moreover, when the variable isReloc=false, the autonomous mobile apparatus 100 can estimate, with a slight amount of error, the attitude of the autonomous mobile apparatus 100 at the time of acquiring the first argument (the image A). Note that, in step S510, the number of matches is compared against 0.8× the reference match value K, but the numerical value 0.8 is merely given by way of example. However, if this numerical value is excessively small, the error will increase. As such, it is preferable that this numerical value be set to a value that is less than 1 but greater than or equal to 0.5.

In the relocalization processing of FIG. 9, processing is illustrated in which the first environment map for which attitude estimation is successful among the candidate environment maps is ultimately selected, but this processing is merely given by way of example. For example, a configuration is possible in which, in the attitude estimation processing (FIG. 10), the number of matches calculated in step S505 is set as a return value and, in the relocalization processing, the numbers of matches of all of the candidate environment maps are calculated and the environment map for which the number of matches is greatest is ultimately selected. Additionally, a configuration is possible in which, in step S505 of the attitude estimation processing (FIG. 10), the coordinate position error of the feature point is also saved for each candidate environment map when calculating the number of matches and, in the relocalization processing, the environment map that has the smallest error among all of the candidate environment maps is ultimately selected.

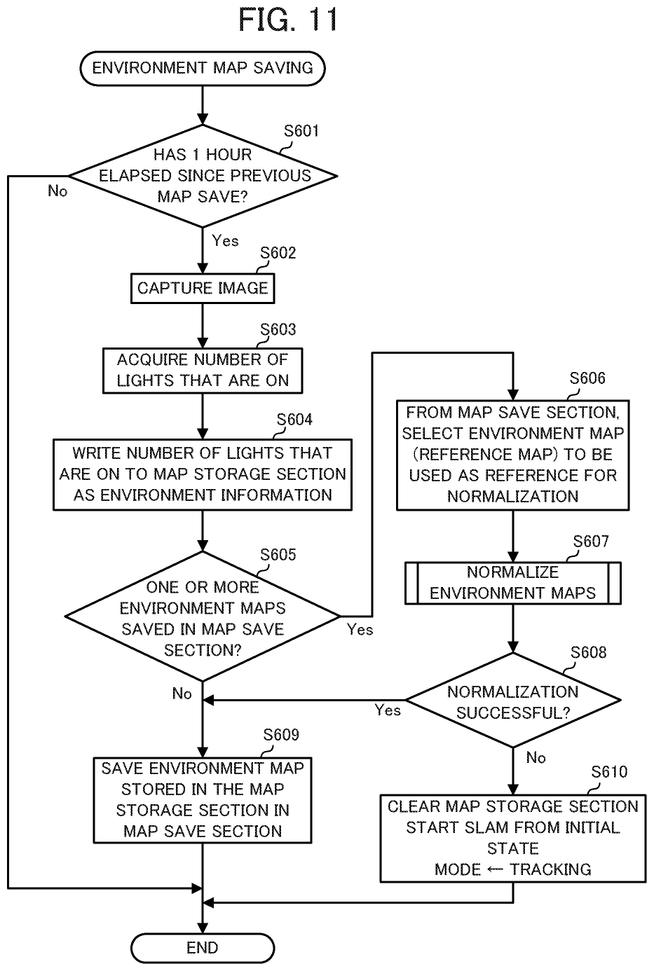

Next, the environment map saving processing that is executed in step S217 of the self position estimation thread (FIG. 7) is described while referencing FIG. 11. In this processing, the map stored in the map storage section 21 is saved in the map save section 22 every predetermined amount of time (for example, every one hour).

First, the controller 10 determines whether the predetermined amount of time (for example, one hour) has elapsed since the environment map was previously saved in the map save section 22 (step S601). If the predetermined amount of time has not elapsed (step S601; No), the environment map saving processing is ended. If the predetermined time has elapsed (step S601; Yes), the controller 10 captures an image using the imaging device 33 (step S602). Then, the controller 10 acquires the number of lights that are ON by counting the number of regions in the image where brightness is high (step S603). Note that, specifically, the regions in the image where brightness is high are regions in which the brightness is greater than or equal to a predetermined brightness reference value. The imaging device 33 includes a wide angle lens capable of imaging a wide range spanning from in front to above the imaging device 33. As such, the ceiling is included in the imaging range and images can be captured in which it is possible to determine the number of lights on the ceiling. In step S603, the controller 10 functions as the environment information acquirer 11.

Then, the controller 10 writes the acquired number of lights that are ON to the map storage section 21 as the environment information (step S604). Next, the controller 10 determines whether one or more environment maps are saved in the map save section 22 (step S605).

If one or more environment maps are saved in the map save section 22 (step S605; Yes), the controller 10 selects, from among the environment maps saved in the map save section 22, an environment map to be used as the reference for normalization (hereinafter referred to as “reference map”) (step S606). In one example, the environment map that was saved first in the map save section 22 is selected as the reference map. Then, the map normalizer 13 performs environment map normalization processing for normalizing the environment maps stored in the map storage section 21, using the reference map selected in step S606 as the reference (step S607). Here, “normalization” means matching the coordinate axis, origin, and scale of the environment maps to the reference map. As described later, the environment map normalization processing is a subroutine that accepts two arguments, namely the environment map to be normalized (hereinafter referred to as “target map”) and the reference map, which is the reference of the normalization. A detailed description of the environment map normalization processing is given later.

Next, the controller 10 determines whether the environment map normalization processing is successful (step S608). If the environment map normalization processing has failed (step S608; No), the controller 10 clears the map storage section 21, starts the SLAM processing from the initial state, sets TRACKING for the variable MODE (step S610), and ends the environment map saving processing. If the environment map normalization processing is successful (step S608; Yes), the controller 10 saves the normalized environment map (the target map) stored in the map storage section 21 in the map save section 22 (step S609). Then, the controller 10 ends the environment map saving processing.

If one or more environment maps are not saved in the map save section 22 (step S605; No), the controller 10 saves the environment map stored in the map storage section 21 in the map save section 22 without modification (the normalization processing is not necessary) (step S609). Then, the controller 10 ends the environment map saving processing.

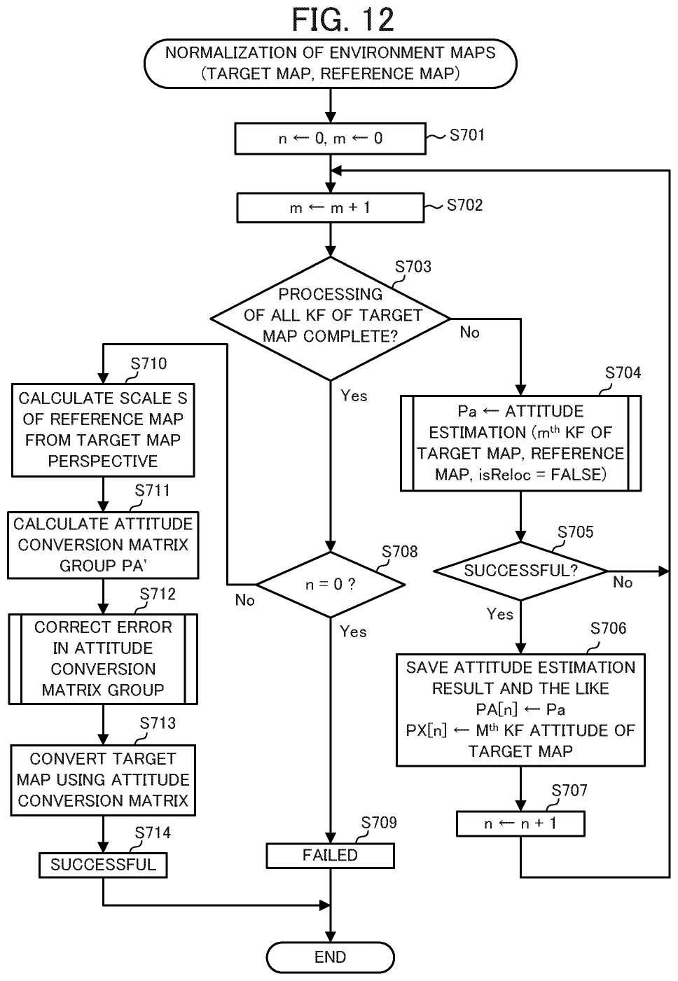

Next, the environment map normalization processing that is called in step S607 of the environment map saving processing (FIG. 11) is described while referencing FIG. 12. As described above, the environment map normalization processing accepts two arguments, namely the environment map to be normalized and the environment map that is the reference of the normalization. In the following description, the environment map to be normalized is referred to as the “target map” and the environment map that is the reference of the normalization is referred to as the “reference map.”

First, the controller 10 substitutes 0 for work variables n and m (step S701). The variable m is used as an index when sequentially handling the key frames included in the target map one at a time. The variable n is used for counting the number of times the attitude (the attitude of the autonomous mobile apparatus 100 at the time of capture of the key frame) of a certain key frame, among the key frames included in the target map, is successfully estimated using the reference map.

Next, the controller 10 adds 1 to the variable m (step S702). Then, the controller 10 determines whether the processing (processing for estimating the attitude of the key frame (described later)) is completed for all of the key frames included in the target map (step S703). If the processing is not completed for all of the key frames included in the target map (step S703; No), the controller 10 performs the attitude estimation processing on the basis of the reference map for the m^{th} key frame of the target map (step S704). As described above, the attitude estimation processing is a subroutine that accepts three arguments, namely the image A, the environment map B, and the flag variable isReloc. However, in the attitude estimation processing called here, the m^{th} key frame of the target map is set for the image A, the reference map is set for the environment map B, and false is set for the flag variable isReloc.

The controller 10 determines whether the attitude estimation processing called in step S704 has successfully performed the attitude estimation (step S705). If the attitude estimation has failed (step S705; No), step S702 is executed. If the attitude estimation is successful (step S705; Yes), the attitude estimation results and the like are saved (step S706). Specifically, the matrix Pa, which is the result of the attitude estimation of the m^{th} key frame of the target map on the basis of the reference map, is substituted into the array variable PA [n], and the 3D attitude of the m^{th} key frame of the target map is substituted into the array variable PX [n]. Then, the controller 10 adds 1 to the variable n (step S707), and executes step S702.

If the processing is complete for all of the key frames included in the target map (step S703; Yes), the controller 10 determines whether the variable n is 0 (step S708). If the variable n is 0 (step S708; Yes), it is determined that the attitude estimation based on the reference map has failed for all of the key frames included in the target map. In this case, since it is not possible to normalize the target map with the reference map, the normalization of the environment map is determined to have failed (step S709) and the environment map normalization processing is ended. In this case, the controller 10 discards and ceases further use of the target map.

If the variable n is not 0 (step S708; No), the controller 10 calculates the scale S of the reference map from the perspective of the target map (the scale S for scaling from the target map to the reference map) (step S710). Specifically, the scale S is calculated using the following Equation (1):

S=sel(std(pos(PA[ ]))/std(pos(PX[ ]))) (1)

Here, pos( ) is a function that extracts a position matrix from each attitude matrix included in the attitude matrix group, and returns a position matrix group formed from the extracted position matrices. The position matrix group is a matrix group in which a plurality (n) of position matrices (column vectors) consisting of three elements, namely x, y, and z, are arranged. Additionally, std( ) is a function that returns a standard deviation calculated from n values for each of the three elements of the argument, namely x, y, and z, of the n position matrices included in the matrix group. The ratio of the standard deviation calculated from PA to the standard deviation calculated form PX can be found for each of the three elements (x, y, and z) from std(pos(PA[ ]))/std(pos(PX[ ])). Moreover, sel( ) is a function for selecting the maximum value among the three ratios calculated for each of the three elements. That is, the scale S is the value with the greatest standard deviation ratio among the various standard deviation ratios of the three elements of the position matrix, namely x, y, and z.

Note that Equation (1) assumes that the autonomous mobile apparatus 100 is traveling on a flat surface. When the autonomous mobile apparatus 100 can freely move in three-dimensional space, the orientations of the attitude matrix group PA and the attitude matrix group PX must be aligned. As such, for example, the scale S can be calculated according to Equation (2) below by extracting, the rotation matrix part RA of the attitude matrix group PA and the rotation matrix part RX of the attitude matrix group PX. Here, tr( ) is a function that takes a transposed matrix (in the rotation matrix, the inverse matrix is a transposed matrix and, as such, in Equation (2), the transposed matrix is calculated in order to find the inverse matrix). Additionally, RA is a rotation matrix that corresponds to the position matrix extracted by pos(PA[ ]), and RX is a rotation matrix that corresponds to the position matrix extracted by pos(PX[ ]).

S=sel(std(pos(PA[ ]))/std(RA·tr(RX)·pos(PX[ ]))) (2)

Next, the controller 10 calculates an attitude conversion matrix group PA′ from the attitude matrix group PX and the attitude matrix group PA (step S711). Specifically, the attitude matrix group PA expresses the 3D attitudes, at the coordinates of the reference map, of the various key frames of the target map. As such, by performing the calculations of the following Equation (3) for the 3D attitudes (the attitude matrix group PX) of the various key frames of the target map, it is possible to calculate the attitude conversion matrix group PA′ for converting from the attitude of the scale-corrected target map to the attitude of the reference map. Note that, in Equation (3), inv( ) represents a function for calculating the inverse matrix.

PA′=PA·inv(S·PX) (3)

The attitude matrix group PA and the attitude matrix group PX each include n attitude matrices and, as such, an attitude conversion matrix group PA′ that includes n attitude conversion matrices can be obtained by performing the calculation of Equation (3) on each of the n attitude matrices included in each attitude matrix group. However, it is thought that, since the attitude estimation processing is called when isReloc=false in step S704, the threshold for the determination in step S510 of the attitude estimation processing (FIG. 10) is set low and, as such, the attitude conversion matrices included in the attitude conversion matrix group PA′ include a relatively large amount of error.

As such, the controller 10 performs attitude conversion matrix error correction processing (step S712). A detailed description of this error correction processing is given later. Then, the controller 10 converts the MapPoint information group and the key frame information group included in the target map using the scale S and the attitude conversion matrix P that has been subjected to the error correction processing (step S713). Specifically, the 3D attitude PX0 of each piece of key frame information included in the target map is converted to a 3D attitude PS normalized with the following Equation (4), and the 3D coordinate MX0 of each piece of the MapPoint information is converted to a 3D coordinate MS normalized with the following Equation (5).

PS=P·S·PX0 (4)

MS=P·S·MX0 (5)

It is determined that the normalization of the environment map is successful (step S714), and the environment map normalization processing is ended. In processing described above, the scale S is found by calculation, but in cases in which the absolute scale is known due to the mechanical odometers or the like, the scale S may be adjusted at the time of initializing SLAM, at the time of saving the environment map, or the like. If the scale matches for the plurality of environment maps, the processing of calculating the scale S in step S710 of the environment map normalization processing (FIG. 12) is not necessary, and the environment maps may be processed with the scale S=1.

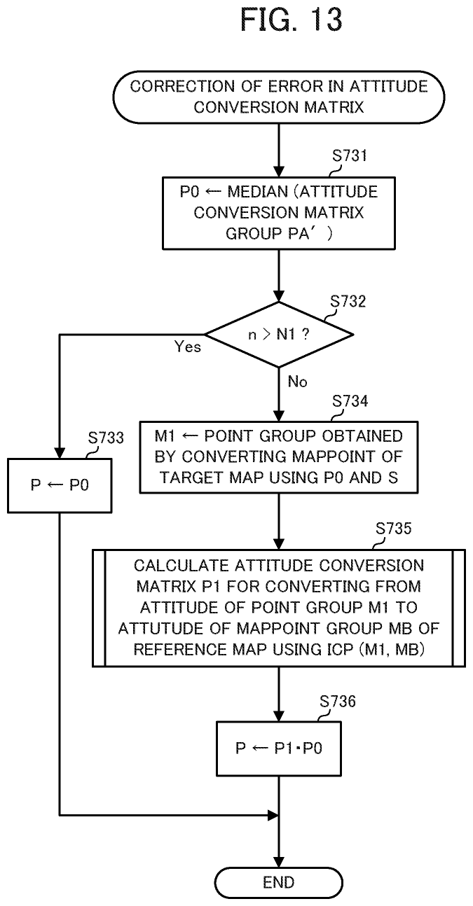

Next, the attitude conversion matrix error correction processing that is executed in step S712 of the environment map normalization processing (FIG. 12) is described while referencing FIG. 13.

First, the controller 10 calculates the median of the n attitude conversion matrices included in the attitude conversion matrix group PA′, and sets this median as attitude conversion matrix P0 (step S731). As described above, since the attitude conversion matrices are expressed in homogeneous coordinate format, they include a rotation matrix and a position matrix. In order to calculate the median of the attitude conversion matrices, the median of the rotation matrix and the median of the position matrix must be found. Since the position matrix is linear, the median of the position matrix can be acquired by finding the median of each element (each of x, y, and z) of the position matrix. The rotation matrix is non-linear and, as such, in order to easily calculate the median of the rotation matrix, processing is performed in which the rotation matrix is converted to a quaternion and projected into linear space, the median is calculated within the linear space and, thereafter, the quaternion is converted back to the rotation matrix and returned to the original non-linear space.

In one example, the rotation matrix can be treated as linear space by handling the rotation matrix with an exponential map. Specifically, first, the rotation matrix is converted to a quaternion q. Techniques for converting rotation matrices to quaternions and quaternions to rotation matrices are well-known. As such, description of such methods are foregone. The quaternion q has four elements, namely w, x, y, and z (q=w+xi+yj+zk), and these four elements can be thought of as a hypersphere (w²+x²+y²+z²=1) in four-dimensional space with these four elements as the four axes, the hypersphere having a radius of 1 and the origin at the center. The tangent space to this hypersphere is called an exponential map. The exponential map is three-dimensional space that contacts the hypersphere that exists in four-dimensional space, and is linear space.

When the quaternion q is expressed as q·w+q·x·i+q·yj+q·z·k, the conversion from the quaternion q to the exponential map (expmap) can, for example, be expressed by the following Equations (6) and (7). Here, a cos( ) represents an inverse cosine function, and sin( ) represents a sine function.

θ₀=a cos(q·w) (6)

expmap=θ₀/sin(θ₀)·[q·x,q·y,q·z] (7)

It is possible to calculate n expmaps using Equations (6) and (7) from the results of converting the various rotation matrix parts, of the n attitude conversion matrices included in the attitude conversion matrix group PA′, to quaternions q. The expmaps calculated here have the three elements of x, y, and z. Therefore, an expmap′ is obtained by taking the median of each of these elements. The expmap′ can be converted back to a quaternion q′ (=q′·w+q′·x·i+q′·y·j+q′·z·k) by using the following Equations (8), (9), and (10). Here, norm( ) represents a function that returns the Euclidean norm, and cos( ) represents a cosine function,

θ₁=norm(expmap′) (8)

q′·w=cos(θ₁) (9)

[q′·x,q′·y,q′·z]=sin(θᵢ)·expmap′/θ₁ (10)

Then, the quaternion q′ is converted to a rotation matrix, and the attitude conversion matrix P0 is obtained by combining the median with the calculated position matrix. Note that, in the example described above, when calculating the attitude conversion matrix P0, the median of n attitude conversion matrices is used, but the use of the median is merely an example. For example, the average may be used to calculate the attitude conversion matrix P0. Alternatively, RANdom Sample Consensus (RANSAC) may be used to select an attitude conversion matrix that supports many key frames (having similar attitudes) or an attitude conversion matrix that supports many MapPoints (having neighboring positions).

The phrase “select an attitude conversion matrix that supports many key frames (having similar attitudes)” means “selecting an attitude conversion matrix, from among the n attitude conversion matrices included in the attitude conversion matrix group PA′, such that the number of key frames that match (or have similarity greater than or equal to a predetermined standard) the 3D attitude of the key frame of the reference map, when the 3D attitude of the key frame of the target map is converted, is greater than a predetermined threshold.” In cases in which a plurality of attitude conversion matrices are selected, the median or the average of the selected attitude conversion matrices may be used or, as described above, the attitude conversion matrix with the greatest number of key frames (that match or have similarity greater than or equal to a predetermined standard) may be selected.

The phrase “select an attitude conversion matrix that supports many MapPoints (having neighboring positions)” means “selecting an attitude conversion matrix, from among the n attitude conversion matrices included in the attitude conversion matrix group PA′, such that the number of MapPoints that match (or have a distance between two points that is less than or equal to a predetermined reference distance) the 3D coordinates of the MapPoint of the reference map, when the 3D coordinates of the MapPoint of the target map are converted, is greater than a predetermined threshold.” In cases in which a plurality of attitude conversion matrices are selected, the median or the average of the selected attitude conversion matrices may be used or, as described above, the attitude conversion matrix with the greatest number of MapPoints (for which the distance between the two points is less than or equal to a predetermined reference distance) may be selected.

Then, the controller 10 determines whether n (the number of attitude conversion matrices included in the attitude conversion matrix group PA′) is greater than a predetermined threshold N1 (for example, a value about 30% of the number of key frames included in the target map) (step S732). If n is greater than N1 (step S732; Yes), it is determined that the error included in the attitude conversion matrix P0 is small, the attitude conversion matrix P0 is set as the attitude conversion matrix P (step S733), the error correction processing is ended, and step S713 of the environment map normalization processing (FIG. 12) is executed.

If n is less than or equal to N1 (step S732; No), the MapPoint is also used to reduce the error in the attitude conversion matrix P0. To achieve this, the controller 10 defines, as M1, a point group obtained by using the attitude conversion matrix P0 and the scale S to convert the 3D coordinates of each MapPoint included in the target map to coordinates in the reference map (step S734). Specifically, when (each 3D coordinate of) the MapPoint group of the target map is expressed as M0, M1 is calculated by Equation (11) below from the attitude conversion matrix P0 and the scale S. M0 includes the 3D coordinates of a plurality of MapPoints. As such, M1 is a point group that includes the 3D coordinates of the same number of points as M0.

M1=P0·S·M0 (11)

Then, when (each 3D coordinate of) the MapPoint group of the reference map is expressed as MB, the controller 10 uses iterative closest point (ICP) processing to calculate an attitude conversion matrix P1 that expresses the attitude change from the point group M1 to the point group MB (step S735). An overview of the ICP processing is given later.

Then, the controller 10 uses Equation (12) to calculate the attitude conversion matrix P from the attitude conversion matrix P0 and the attitude conversion matrix P1 (step S736), ends the error correction processing, and executes step S713 of the environment map normalization processing (FIG. 12).

P=P1·P0 (12)

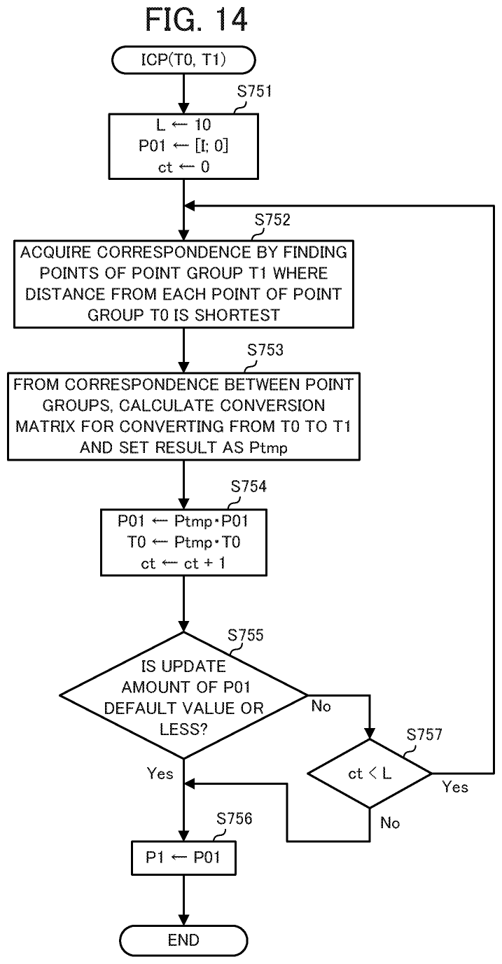

Next, the ICP processing that is executed in step S735 of the error correction processing (FIG. 13) is described while referencing FIG. 14. The ICP processing accepts two point groups as arguments and defines these as point group T0 and point group T1, respectively. When the ICP processing is called in step S735 of the error correction processing (FIG. 13), the point group M1 is substituted for the point group T0, the point group MB is substituted for the point group T1, and the processing is started. Note that, typically, ICP processing is highly dependent on the initial value, which is a problem. However, as described above, the point group M1, which is obtained by converting the MapPoint group of the target map using the attitude conversion matrix P0, is given as the initial value. As such, the error in the initial value is small and the initial value dependency problem can be avoided.

First, the controller 10 substitutes a maximum number of loops (for example, 10) into a work variable L, substitutes 0 into a work variable ct, and substitutes a homogeneous coordinate format matrix, in which the rotation matrix part is a unit matrix and the position matrix part is a 0 vector, as the initial value of the attitude conversion matrix P01 (to be calculated) for converting from the point group T0 to the point group T1 (step S751).

Then, the controller 10 acquires correspondence by finding points among the point group T1 where the distance from each point of the point group T0 is shortest (step S752). Next, on the basis of the correspondence between the point group T0 and the point group T1, the controller 10 calculates the attitude conversion matrix for converting from the point group T0 to the point group T1, and sets the result as attitude conversion matrix Ptmp (step S753).

Then, the controller 10 updates the attitude conversion matrix P01 and the point group T0 to those obtained by converting using the attitude conversion matrix Ptmp, and adds 1 to the work variable ct (step S754). Next, the controller 10 determines whether the update amount (the difference before and after converting the attitude conversion matrix P01 using the attitude conversion matrix Ptmp) of the attitude conversion matrix P01 in step S754 is less than or equal to a predetermined default value (step S755).

If the update amount of the attitude conversion matrix P01 is less than or equal to the default value (step S755; Yes), it is determined that the attitude conversion matrix P01 converged, the controller 10 substitutes the attitude conversion matrix P01 into the attitude conversion matrix P1, which is the return value of the ICP processing (step S756), and the ICP processing is ended.

If the update amount of the attitude conversion matrix P01 exceeds the default value (step S755; No), the controller 10 determines if the work variable ct is less than the maximum number of loops L (step S757). If the work variable ct is less than the maximum number of loops L (step S757; Yes), step S752 is executed and the updating of the attitude conversion matrix P01 is repeated.

If the work variable ct is greater than or equal to the maximum number of loops L (step S757; No), it is determined that sufficient convergence will not be obtained by repeating the updating of the attitude conversion matrix P01, the controller 10 substitutes the attitude conversion matrix P01, which is the return value of the ICP processing, into the attitude conversion matrix P1 (step S756), and the ICP processing is ended.

As a result of the attitude conversion matrix error correction processing and the ICP processing described above, it is possible to reduce the error of the attitude conversion matrix P, thereby enabling the environment map normalization processing to normalize the target map with the reference map using an attitude conversion matrix P with a small amount of error.

Moreover, as a result of the environment map normalization processing described above, the environment map data, to which the environment information is added every predetermined amount of time, is saved in the map save section 22 after being normalized with the reference map. Accordingly, the autonomous mobile apparatus 100 can handle a plurality of environment maps in a unified manner, thereby enabling self position estimation that is robust against changes in the environment.

Note that, in the environment map normalization processing (FIG. 12) described above, an example is described in which the normalization failed only when the variable n is 0, but a configuration is possible in which normalization fails when n is less than or equal to a predetermined threshold N2 (for example, a threshold set to a value about 5% of the number of key frames included in the target map). Additionally, in the attitude conversion matrix error correction processing (FIG. 13) described above, an example is described in which, in step S732, the controller 10 determines whether n is greater than the predetermined threshold N1 and, if n is less than or equal to N1, processing is performed in which the MapPoint is also used to reduce the error of the attitude conversion matrix P0. However, this processing may be omitted. That is, the attitude conversion matrix P0, which is obtained by calculating the median or the like from the attitude conversion matrix group PA′ that includes n attitude conversion matrices, may be used as the final attitude conversion matrix P. Conversely, in the attitude conversion matrix error correction processing (FIG. 13) described above, a configuration is possible in which processing is performed in which the MapPoint is used to reduce the error of the attitude conversion matrix P0, regardless of the value of n.

### Modified Example 1 of Embodiment 1

In Embodiment 1, an example is described in which, in step S606 of the environment map saving processing (FIG. 11), when selecting the reference map (the environment map saving processing to be used as the reference for normalization), the first environment map that was saved in the map save section 22 is selected as the reference map. However, the method of selecting the reference map is not limited thereto. An example of another method that can be used is a method in which a large-scale environment map is selected from among the environment maps saved in the map save section 22 as the reference map. Here, the phrase “large-scale” means that the number of key frames included in the environment map is great or the number of MapPoints is great. Next, Modified Example 1 of Embodiment 1, in which a large-scale environment map is selected as the reference map, will be described.

In Embodiment 1, the first environment map that was saved in the map save section 22 is used as the reference map. As such, all newly created environment maps are saved, with the coordinate axes, origins, and scales matched to the environment map saved first (the reference map). That is, there is only one reference map, and this reference map does not change. In contrast, in the Modified Example 1 of Embodiment 1, when an environment map with a larger scale than the previously saved environment maps is stored in the map save section 22, the reference map selected thereafter in the environment map saving processing is a different environment map than the prior reference map. In other words, the reference map can change.

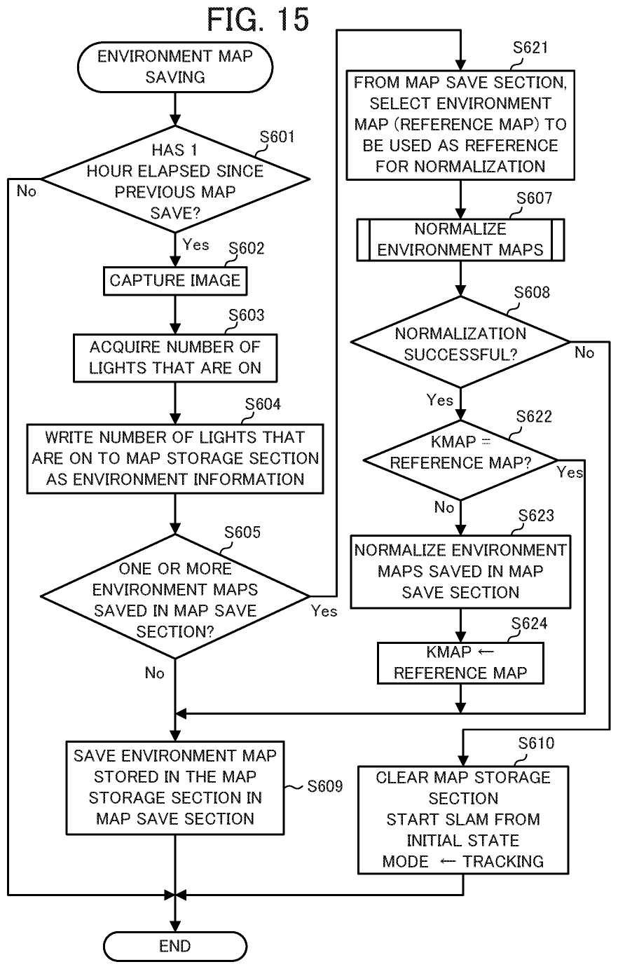

Accordingly, as illustrated in FIG. 15, the environment map saving processing of Modified Example 1 of Embodiment 1 performs processing in which a variable KMAP that indicates the map ID of the current reference map is introduced, and when the reference map changes, the other environment maps saved in the map save section 22 are re-normalized using the new reference map. Note that, processing is performed in which the variable KMAP is initialized (set to a nonexistent map ID such as 0) at the beginning of step S102 of the startup processing (FIG. 6) as preparation for using the variable KMAP.

The environment map saving processing (FIG. 15) of Modified Example 1 of Embodiment 1 includes the environment map saving processing (FIG. 11) of Embodiment 1 and, in addition, the processing of step S621 to S624. As such, the added steps will be described.

In step S621, the controller 10 selects, as the reference map, a large-scale environment map from among the environment maps saved in the map save section 22. For example, the environment map for which the sum of the number of key frames and the number of MapPoints included in the environment map is the greatest is selected as the reference map. Instead of selecting the environment map with the greatest simple sum as the reference map, a configuration is possible in which the environment map for which sum of the number of key frames and the number of MapPoints are respectively weighted, and the environment map with the greatest weighted sum is selected as the reference map.

In step S622, the controller 10 determines whether the value stored in the variable KMAP is the same as the map ID of the reference map selected in step S621. If the value is the same (step S622; Yes), step S609 is executed. This is because, in this case, the environment map saved in the map save section 22 has already been normalized with the reference map.

If the value stored in the variable KMAP is not the same as the map ID of the reference map (step S622; No), the controller 10 re-normalizes the environment maps (all of the environment maps with the exception of the reference map) saved in the map save section 22 with the reference map and re-saves the normalized environment maps in the map save section 22 (step S623). Then, the controller 10 sets the map ID of the reference map for the variable KMAP (step S624) and executes step S609.

In the environment map saving processing of the Modified Example 1 of Embodiment 1 described above, the environment map with the large scale is selected as the reference map. As such, there is a greater possibility of the reference map including various key frames and MapPoints. Therefore, there is a greater possibility that many key frames and MapPoints of locations that are less affected by lighting (under desks and the like) are included, and it is expected that normalization of the environment maps will be more likely to succeed. Accordingly, a greater number of environment maps can be normalized, thereby enabling self position estimation that is more robust against changes in the environment.

### Modified Example 2 of Embodiment 1

In Embodiment 1 described above, if the relocalization processing has failed continuously for the predetermined amount of time or longer, the SLAM processing is initialized (and the map storage section 21 is cleared). However, the timing at which the SLAM processing is initialized (and the map storage section 21 is cleared) is not limited to this timing. For example, the initialization of the SLAM processing (and the clearing of the map storage section 21) may be performed after the environment maps stored in the map storage section 21 are saved in the map save section 22 in the environment map saving processing (FIG. 11). Next, Modified Example 2 of Embodiment 1, which is an example of such a case, will be described.

In Modified Example 2 of Embodiment 1, after the processing of step S609 of the environment map saving processing (FIG. 11), step S610 is executed and, after the processing of step S610, the environment map saving processing is ended.

According to the processing described above, a new environment map is created from the initial state each time an environment map in saved the map save section 22. As such, the Modified Example 2 of Embodiment 1 can save, in the map save section 22, environment maps that reflect the most recent environment information. Thus, environment maps for a variety of environment information are saved in the map save section 22 and, as such, when re-selecting the environment map, it is more likely that an environment map that better matches the current environment will be selected.

### Modified Example 3 of Embodiment 1

Furthermore, the timing at which the SLAM processing is initialized (and the map storage section 21 is cleared) may be a timing other than those described above. For example, in the self position estimation thread (FIG. 7), if the relocalization processing (step S218) does not succeed with the current environment map after a set amount of time has elapsed, the SLAM processing may be initialized (and the map storage section 21 may be cleared). Next, Modified Example 3 of Embodiment 1, which is an example of such a case, will be described.

In Modified Example 3 of Embodiment 1, a variable RFC2 that counts the failures of the relocalization processing is introduced. When the relocalization processing (step S218), with the current environment map, of the self position estimation thread (FIG. 7) is successful (step S219; Yes), 0 is set to the variable RFC2, and when the relocalization processing has failed (step S219; No), 1 is added to the variable RFC2. When the variable RFC2 exceeds a predetermined value (for example, 5), the SLAM processing is initialized (and the map storage section 21 is cleared), and the processing is performed again from step S202. Alternatively, the time when the variable RFC2 becomes 1 is recorded in a variable RFT2, and if the relocalization processing continues to fail with the current environment map after a predetermined amount of time (for example, 5 minutes) has elapsed from the time of RFT2, the SLAM processing is initialized (and the map storage section 21 is cleared), and the processing is performed again from step S202.

According to the processing described above, the Modified Example 3 of Embodiment 1 can prevent the relocalization processing with the current environment map from falling into an unending failure loop.

### Modified Example 4 of Embodiment 1

As an example of the timing of the initialization of the SLAM processing, the SLAM processing may be initialized (and the map storage section 21 may be cleared) when the number of the environment maps stored in the map save section 22 at the start timing of the self position estimation thread (FIG. 7) is less than or equal to a predetermined environment map reference number. Next, Modified Example 4 of Embodiment 1, which is an example of such a case, will be described.

In Modified Example 4 of Embodiment 1, in step S201 of the self position estimation thread (FIG. 7), instead of determining whether an environment map is saved in the map save section 22, it is determined whether the number of environment maps saved in the map save section 22 is greater than or equal to an environment map reference number (for example, 5). If the number of environment maps that are saved is less than the environment map reference number (step S201; No), SLAM is started from the initial state. Additionally, when the relocalization processing (step S204) has failed, instead of step S204, step S203 may be executed and the environment map with the highest possibility of matching the current environment may be extracted from the plurality of environment maps. Furthermore, when the relocalization processing with the current environment map (step S218) has failed multiple times, step S203 may be executed and the environment map with the highest possibility of matching the current environment may be extracted from the plurality of environment maps. Moreover, when the relocalization processing has failed in step S204 and/or step S218, step S202 may be executed, the SLAM processing may be initialized (and the map storage section 21 may be cleared), and processing for creating a new environment map may be started.

As a result of the processing described above, the Modified Example 4 of Embodiment 1 creates different environment maps until a certain number of environment maps are saved in the map save section 22. As such, the possibility of environment maps based on various environments being saved in the map save section 22 increases. Moreover, if the processing is repeated from the environment map extraction (step S203) when the relocalization processing has failed, the possibility of extracting an environment map that matches the current environment increases and, as a result, self position estimation that is robust against changes in the environment can be performed.

### Modified Example 5 of Embodiment 1

In the Embodiments described above, when the environment map normalization processing (FIG. 11) in the environment map saving processing has failed (step S608; No), the environment map stored in the map storage section 21 is discarded and that environment map is no longer used. However, it is thought that the environment map normalization processing will fail most of the time when, for example, there are many abnormal values in the reference map. As such, a configuration is possible in which, when the normalization continuously fails, it is determined that the reference map includes abnormalities, and the controller 10 deletes the reference map from the map save section 22. Next, Modified Example 5 of Embodiment 1, in which the reference map is deleted from the map save section 22 when the normalization of the environment map is not successful, will be described.

In Modified Example 5 of Embodiment 1, a variable FC is introduced. The variable FC is for counting the number of times the normalization continuously fails in the environment map saving processing (FIG. 11). If the normalization is successful (step S608; Yes), the controller 10 sets the variable FC to 0, and executes step S609. Meanwhile, if the normalization has failed (step S608; No), the controller 10 adds 1 to the variable FC. If the value of FC exceeds a predetermined value (for example, 5), the reference map is deleted from the map save section 22. Then, one environment map (for example, the environment map with the largest scale) is selected from among the remaining environment maps saved in the map save section 22, the selected environment map is set as the reference map, and the normalization of the other environment maps saved in the map save section 22 is performed again. Then, normalization of the environment maps stored in the map storage section 21 is attempted with the new reference map. If the normalization of the environment maps stored in the map storage section 21 with the new reference map is successful, the variable FC is set to 0 and step S609 is executed.

If the normalization fails even with the new reference map, there is a possibility that, instead of the reference map, there is a problem with the environment maps stored in the map storage section 21. As such, the variable FC is set to 1 and step S610 is executed. If, thereafter, the normalization of the environment maps continues to fail and the value of FC exceeds the predetermined value (for example, 5), the reference map is deleted from the map save section 22, and the aforementioned processing is repeated.

According to the processing described above, the Modified Example 5 of Embodiment 1 can prevent the normalization of the environment maps from falling into an unending failure loop when there is a problem with the reference map.

### Embodiment 2

In Embodiment 1 it is possible to set a desired environment map that is saved in the map save section 22 as the environment map that is used as the reference for the normalization (reference map). However, there is a cost involved with calculating the attitude conversion matrix P when normalizing. Therefore, in Embodiment 2, an example is described in which normalization can be performed while suppressing calculation costs by introducing an attitude (reference attitude) that is used as a reference when normalizing the various environment maps.

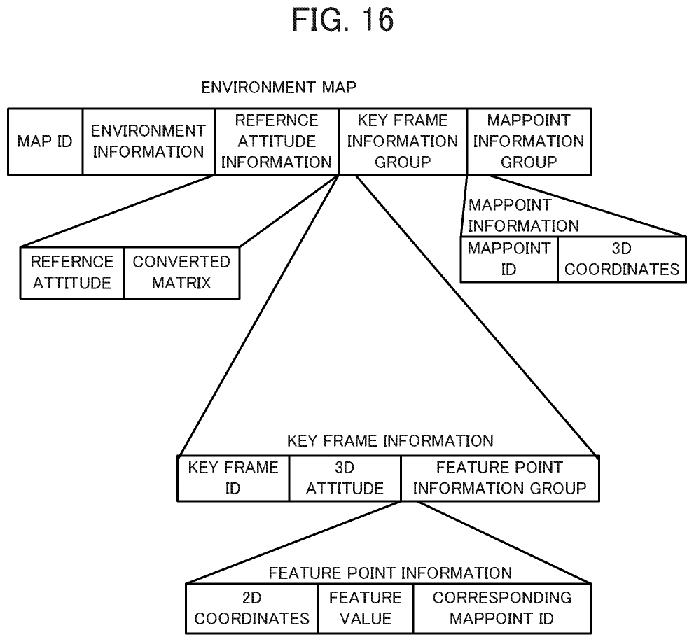

The autonomous mobile apparatus 101 according to Embodiment 2 has the same appearance and configuration as the autonomous mobile apparatus 100 according to Embodiment 1. However, as illustrated in FIG. 16, the environment map stored in the map storage section 21 has a data structure wherein reference attitude information is added to the environment map of Embodiment 1. The reference attitude information includes a reference attitude and a converted matrix. The reference attitude is the attitude that is used as the reference when normalizing the environment maps. The attitude of the autonomous mobile apparatus 101 at a predetermined location (for example, the installation location of the charger 200) is typically registered as the reference attitude. The converted matrix is the attitude conversion matrix used when normalizing the environment maps.

Both the reference attitude and the converted matrix are expressed by 4×4 homogeneous coordinate format attitude matrices that include a 3×3 rotation matrix and a 3×1 position matrix. At the time of start of the environment map generation (time of initialization), all of the elements of the reference attitude are initialized to matrices of 0 (0 matrices), and the converted matrix is initialized such that the rotation matrix part is a unit matrix and the position matrix part is a 0 matrix.

The autonomous mobile apparatus 101 can cause the drivers 32 to function as mechanical odometers, and the controller 10 can acquire the movement distance via these mechanical odometers. Moreover, the map creator 12 uses the mechanical odometers to create the environment map so that the unit (scale) of the 3D attitudes of the key frames included in the environment map, the 3D coordinates of the MapPoints, and the like are expressed by the Metric system. In other words, the unit (scale) of length of the environment map is set so that the unit length of 1 in the environment map is equal to one meter in corresponding real 3D space. As a result, the unit (scale) of the attitude of the autonomous mobile apparatus 101 that is estimated by the self position estimator 14 is also expressed by the Metric system.

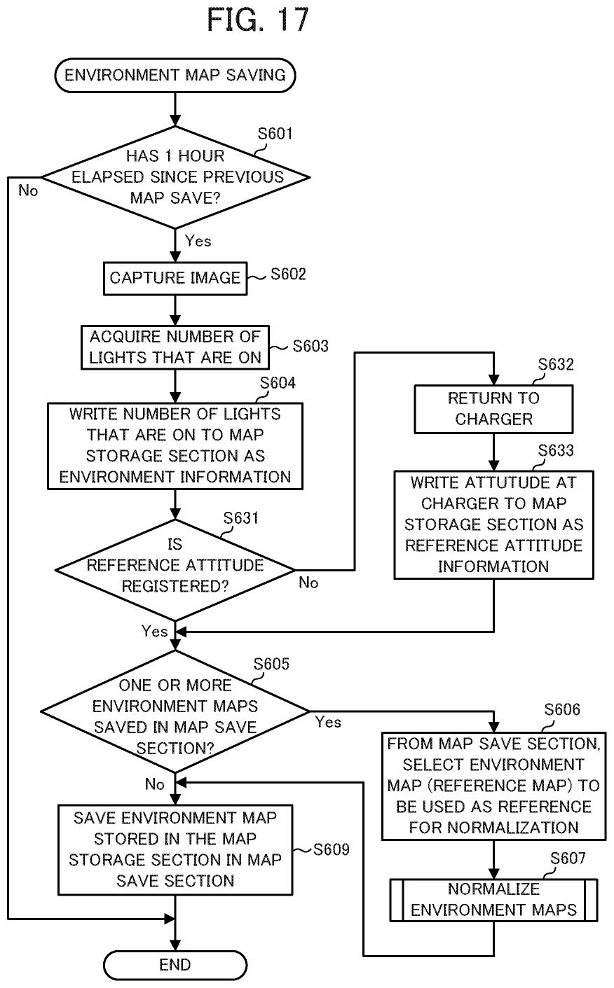

Among the various processes started by the autonomous mobile apparatus 101, the environment map saving processing and the environment map normalization processing include portions that differ from the processes started by the autonomous mobile apparatus 100. As such, these processes will be described. First, the environment map saving processing will be described while referencing FIG. 17. Note that, many portions of the environment map saving processing of the autonomous mobile apparatus 101 are the same as in the environment map saving processing of the autonomous mobile apparatus 100 (FIG. 11). As such, in the following description, the different portions will be focused on.

In the environment map saving processing of the autonomous mobile apparatus 101, after step S604, the controller 10 determines whether the reference attitude is recorded in the environment map stored in the map storage section 21 (step S631). If the reference attitude is a 0 matrix, the reference attitude is not recorded (step S631; No) and, as such, the controller 10 performs control to return the autonomous mobile apparatus 101 to the installation location of the charger 200 (step S632).

Then, when the autonomous mobile apparatus 101 has returned to the installation location of the charger 200, the controller 10 writes the attitude of the autonomous mobile apparatus 101 at the position of the charger 200 to the map storage section 21 as the reference attitude (step S633). Note that the attitude of the autonomous mobile apparatus 101 at the position of the charger 200 may be calculated by SLAM processing, or may be obtained via mechanical odometry.

The subsequent processing is substantially the same as that described above for the environment map saving processing (FIG. 11) of the autonomous mobile apparatus 100.

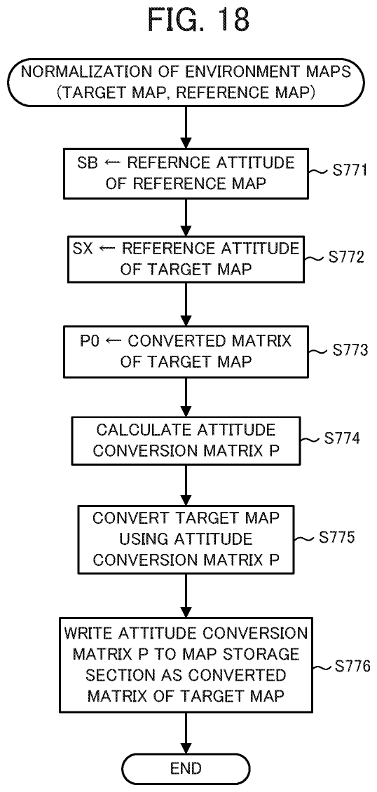

However, as described later, since the normalization in the environment map normalization processing (FIG. 18) of the autonomous mobile apparatus 101 does not fail (always is successful), the processing of step S608 and step S610 of the environment map saving processing (FIG. 11) of the autonomous mobile apparatus 100 is not necessary.

Next, the environment map normalization processing of the autonomous mobile apparatus 101 will be described while referencing FIG. 18. As in Embodiment 1, the environment map normalization processing accepts two arguments, namely the environment map to be normalized and the environment map that is the reference of the normalization. In the following description, the environment map to be normalized is referred to as the “target map” and the environment map that is the reference of the normalization is referred to as the “reference map.”

First, the controller 10 substitutes the reference attitude of the reference map into a variable SB that stores the reference attitude (step S771). Next, the controller 10 substitutes the reference attitude of the target map into a variable SX that stores the reference attitude (step S772). Next, the controller 10 substitutes the converted matrix of the target map into the variable P0 that stores the converted matrix (step S773).

Then, the controller 10 calculates, on the basis of the reference attitude SB of the reference map, the reference attitude SX of the target map, and the converted matrix P0 of the target map, the attitude conversion matrix P for converting from the attitude of the target map to the attitude of the reference map (step S774). Specifically the attitude conversion matrix P is calculated using the following Equation (13). Here, inv( ) is a function for calculating the inverse matrix.

P=SB·inv(SX)·inv(P0) (13)

Next, the controller 10 converts the MapPoint information group and the key frame information group included in the target map using the attitude conversion matrix P (step S775). Specifically, the 3D attitude PX0 of each piece of key frame information included in the target map is converted to a 3D attitude PS normalized with the following Equation (14), and the 3D coordinate MX0 of each piece of the MapPoint information is converted to a 3D coordinate MS normalized with the following Equation (15).

PS=P·PX0 (14)

MS=P·MX0 (15)

Then, the controller 10 writes the attitude conversion matrix P to the map storage section 21 as the attitude conversion matrix of the target map (step S776), and ends the environment map normalization processing.

In the processing described above, the autonomous mobile apparatus 101 assumes, by mechanical odometry, that the scales of all of the environment maps match and, as such, the calculation of the scale S is omitted. However, a configuration is possible in which the scale S calculated using the same processing as Embodiment 1 when there is a possibility that the scales fluctuate from environment map to environment map. In such a case, the attitude conversion matrix P must also be multiplied by the scale S in Equations (14) and (15).

In the processing described above, the attitude of the autonomous mobile apparatus 101 at the position of the charger 200 is used as the reference attitude, but this is merely an example of the reference attitude. For example, the attitude of the autonomous mobile apparatus 101 at a position in front of a television and separated a predetermined distance from the television may be used as the reference attitude. In this case, the front of the television can be recognized, using general image recognition, from an image captured by the imaging device 33. Moreover, when, for example, moving freely in a room, the attitude of the autonomous mobile apparatus when a television of a specific size is recognized at a specific location in a captured image can be used as the reference attitude.

Since the autonomous mobile apparatus 101 according to Embodiment 2 described above normalizes (matches the coordinate system) the environment maps using the reference attitude, the reference attitude must be acquired before saving the environment maps. However, in Embodiment 2, it is possible to calculate the attitude conversion matrix for normalizing by simply performing matrix operations using the reference attitude. As such, there is no risk of the normalization failing, calculation cost can be reduced, and normalization can be reliable performed, which are benefits.

In the embodiments described above, the environment map saving processing saves the maps stored in the map storage section 21 in the map save section 22 every predetermined amount of time (for example, every 1 hour). However, this determination of “every predetermined amount of time” is merely an example. For example, a determination of “when the ambient brightness changes a predetermined amount or greater” may be employed. In this case, the determination in step S601 of the environment map saving processing (FIGS. 11, 15, and 17) becomes “a determination of whether the environment information has changed a predetermined amount or greater from the environment information at the time of the previous saving of the map.”

In the embodiments described above, the number of lights that are ON is used as the environment information, but this is merely an example of the environment information. For example, a two-dimensional vector value consisting of “whether a light is ON” and “the ambient brightness” may be used as the environment information. In such a case, the first value of the two-dimensional vector of the environment information (whether the light on the ceiling is ON or OFF) is a binary value, that is, is set to 1 if the light is ON and 0 if the light is OFF, and the second value of the two dimensional vector of the environment information (the ambient brightness) is the average or the median of all of the pixel values included in the image captured by the imaging device 33.

In the environment map extraction processing (FIG. 8), the similarity between the two-dimensional vector of the environment information obtained by image capturing and the two-dimensional vector of the environment information added to each environment map saved in the map save section 22 is calculated, and N candidate environment maps are extracted in descending order of similarity. Note that, the similarity between the two-dimensional vectors can, for example, be obtained by normalizing the norm of each vector with 1 and then taking the inner product.

When using more information as the environment information, it is possible to increase the number of dimensions of the vector that expresses the environment information to enable handling of the greater amount of information. Moreover, even when the number of dimensions of the vector is increase, the similarity of the environment information can be calculated by normalizing the norms of the two vectors, for which similarity is to be calculated, with 1, and then taking the inner product. In the example described above, an example is given in which the environment information is expressed as a vector, but the environment information need not necessarily be expressed as a vector and other data structures may be used.

In the embodiments described above, the effects of lighting changes (lighting fluctuation) were described for the environment information. Here, “lighting fluctuation” refers particularly to changes in the lighting direction and the light position. Specifically, lighting fluctuation refers to the ON/OFF state of a light, the light entering through a window changing due to the position of the sun, the open/closed state of blinds, and the like.

The feature values of the captured image change when lighting fluctuation occurs, and it is thought that this will affect the position estimation of the autonomous mobile apparatus 100, 101. As such, in the Embodiments described above, changes in lighting are described as an example of the environment information. However, the environment information is not limited thereto. The environment information can include position changes of structures, or the like, that are feature points. For example, in cases in which the positions and/or amounts of objects changes periodically, such as in a warehouse, the environment information may include the positions and/or amounts of the objects.

In such a case, the controller 10 may acquire information about the positions and/or amounts of the objects by general image recognition from images captured by the imaging device 33. Moreover, the controller 10 may acquire information about the positions and/or amounts of the objects by communicating, via the communicator 34, with an external warehouse management system or the like that performs inventory control of the warehouse.

If the amounts of the objects are included in the environment information, the environment information will be different when the warehouse is full of the objects and when there are few objects in the warehouse, and the controller 10 will create individual environment maps for each case. As such, self position estimation that is robust against changes in the amounts of the objects can be performed.

The embodiments and the modified examples described above can be combined as desired. For example, by combining Modified Examples 2, 3, and 4 of Embodiment 1, environment maps based on various environments will be normalized and saved in the map save section 22 and, when the relocalization processing has failed, an environment map will be extracted from the various environment maps that not only matches the current environment but is also normalized. As such, self position estimation that is robust against changes in the environment can be performed.

Note that, the various functions of the autonomous mobile apparatus 100, 101 can be implemented by a computer such as a typical personal computer (PC). Specifically, in the embodiments described above, examples are described in which the program performed by the autonomous mobile apparatuses 100, 101 is stored in advance in the ROM of the storage unit 20. However, a computer may be configured that is capable of realizing these various features by storing and distributing the programs on a non-transitory computer-readable recording medium such as a compact disc read-only memory (CD-ROM), a digital versatile disc (DVD), a magneto-optical disc (MO), a memory card, and universal serial bus (USB) memory, and reading out and installing these programs on the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An autonomous mobile apparatus comprising:
a processor; and
a memory; wherein
the processor is configured to
use captured images to create environment maps in accordance with changes in a surrounding environment,
normalize the created environment maps to enable unified handling, and save the normalized environment maps in the memory, and
estimate a position of the autonomous mobile apparatus using the normalized environment maps.

2. The autonomous mobile apparatus according to claim 1, wherein the processor is configured to
select, from the environment maps, a reference map that is an environment map to be used as a reference for the normalization, and
normalize, based on the reference map, a target map that is an environment map, among the environment maps, to be normalized based on the reference map.

3. The autonomous mobile apparatus according to claim 2, wherein
the environment maps include information about a key frame that is an image, of the captured images, to be used in the estimation of the position, and information about a MapPoint that is a feature point, of feature points that are characteristic points included in the captured images, for which coordinates of the position are estimated, the environment map further including, as the information about the key frame, information about an attitude of the autonomous mobile apparatus taken when the key frame is captured, and
the processor is configured to normalize the target map by converting each of the information about the attitude and the information about the MapPoint that are included in the target map to a value in a coordinate system of the reference map.

4. The autonomous mobile apparatus according to claim 3, wherein the processor is configured to
calculate an attitude conversion matrix for converting from the attitude in the target map to the attitude in the reference map, the calculation being based on the attitude of the autonomous mobile apparatus that is taken when the key frame is captured and that is estimated by correspondence between the key frame included in the target map and a key frame that is included in the reference map and similar to the key frame included in the target map, and
normalize the environment maps using the attitude conversion matrix.

5. The autonomous mobile apparatus according to claim 4, wherein the processor is configured to
calculate an attitude conversion matrix group that is a group of attitude conversion matrices by calculating the attitude conversion matrix using each of a plurality of the key frames included in the target map, and
calculate one attitude conversion matrix with an error reduced using the attitude conversion matrices included in the attitude conversion matrix group.

6. The autonomous mobile apparatus according to claim 5, wherein the processor is configured to calculate the one attitude conversion matrix by calculating a median of the attitude conversion matrices included in the attitude conversion matrix group.

7. The autonomous mobile apparatus according to claim 6, wherein the processor is configured to, when calculating the median of the attitude conversion matrices, convert a rotation matrix extracted from each of the attitude conversion matrices to a quaternion, and project the quaternion in linear space in order to calculate the median in linear space.

8. The autonomous mobile apparatus according to claim 5, wherein the processor is configured to, when a number of the attitude conversion matrices included in the attitude conversion matrix group is less than or equal to a predetermined threshold, reduce an error of the one attitude conversion matrix using the MapPoint included in the environment map.

9. The autonomous mobile apparatus according to claim 4, wherein the processor is configured to delete the target map and start creation of a new environment map when the calculation of the attitude conversion matrix for converting from the attitude in the target map to the attitude in the reference map fails.

10. The autonomous mobile apparatus according to claim 3, wherein
the environment map further includes information about a reference attitude that is an attitude that is a reference in the normalization, and
the processor is configured to
calculate, based on the reference attitude, an attitude conversion matrix for converting from the attitude in the target map to the attitude in the reference map, and
normalize the target map using the attitude conversion matrix.

11. The autonomous mobile apparatus according to claim 10, wherein the processor is configured to determine whether the reference attitude is registered in the target map before normalizing the target map and, when the reference attitude is not registered, cause the autonomous mobile apparatus to move to a predetermined location at which the reference attitude is to be registered, and at the predetermined location, register the reference attitude in the target map.

12. The autonomous mobile apparatus according to claim 11, wherein the predetermined location at which the reference attitude is to be registered is an installation location of a charger that charges the autonomous mobile apparatus.

13. The autonomous mobile apparatus according to claim 3, wherein the processor is configured to
calculate a scale that is a ratio of a length in the reference map to a corresponding length in the target map, the calculation being based on a ratio of a standard deviation of each element of a position vector extracted from information about the attitude that is included in the reference map to a standard deviation of each element of a position vector extracted from information about the attitude that is included in the target map, and
normalize the environment maps using the scale.

14. The autonomous mobile apparatus according to claim 1, wherein the change in the surrounding environment is a change in lighting.

15. The autonomous mobile apparatus according to claim 1, wherein the autonomous mobile apparatus estimates the position where the autonomous mobile apparatus exist currently.

16. An autonomous movement method for an autonomous mobile apparatus, the method comprising:
using captured images to create environment maps in accordance with changes in a surrounding environment;
normalizing the created environment maps to enable uniform handling, and saving the normalized environment maps in a memory; and
estimating a position of the autonomous mobile apparatus using the normalized environment maps.

17. A non-transitory recording medium that stores a program causing a computer of an autonomous mobile apparatus to:
use captured images to create environment maps in accordance with changes in a surrounding environment;
normalize the created environment maps to enable uniform handling, and save the normalized environment maps in a memory; and
estimate a position of the autonomous mobile apparatus using the normalized environment maps.
